(19) United States
(12) Patent Application Publication
(10) Pub. No.: US 2009/0041943 A1
(43) Pub. Date: Feb. 12, 2009

(54) METHOD FOR FORMING BRIGHT COATING FILM

(75) Inventors: Takeshi OGAWA, Saitama (JP); Takanori HASHIMOTO, Saitama (JP); Emi NOMI, Saitama (JP); Yutaro KAWASAKI, Osaka (JP); Yoshihiko SAITO, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: HONDA MOTOR CO., LTD., Tokyo (JP); NIPPON BEE CHEMICAL CO., LTD., Osaka (JP)

(21) Appl. No.: 12/188,391

(22) Filed: Aug. 8, 2008

(30) Foreign Application Priority Data
Aug. 9, 2007 (JP) 2007-208629

(51) Int. Cl. B05D 3/02

(52) U.S. Cl. 427/385.5

(57) ABSTRACT

A method for forming a bright coating film includes: (1) applying a water-based primer coating material composition to a substrate to form a water-based primer coating film; (2) applying a water-based bright coating material (i) to the water-based primer coating film to form a first base coating film; (3) applying a water-based bright coating material (ii) to the first base coating film to form a second base coating film; (4) applying a high-solid clear coating material to the second base coating film to form a clear coating film; and (5) heat-curing the water-based primer coating film, the first base coating film, the second base coating film, and the clear coating film simultaneously to form a cured coating film, wherein the water-based primer coating material composition includes a water-based non-chlorinated polyolefin resin (A), a water-based polyurethane resin (B), a water-based epoxy resin (C), and an internally crosslinked acrylic particle emulsion (D), and an emulsifier.

### TECHNICAL FIELD

The present invention relates to a method for forming a bright coating film.

### BACKGROUND ART

In substrates such as plastic materials used for automobile's bumpers, molds and the like, the wettability of a coating material on the substrates is generally poor and the adhesion property of the coating material to the substrates is poor. In particular, when the plastic material is a polypropylene resin and the like, since these resins are chemically inactive, the adhesion property of a top coating film to the substrate is poor. Therefore, it has been commonly implemented to apply a primer before applying the top coating material. As the primer, various solvent type primers have been studied and used, but in recent several years, water-based primers without using an organic solvent have been proposed and used in view of the environment.

As a conventional water-based primer, a primer including a water-based chlorinated polyolefin resin, a water-based alkyd resin and a water-based novolac epoxy resin is disclosed in Patent Document 1, and a primer including a water-based chlorinated polyolefin resin, a water-based urethane resin, a water-based epoxy resin, and an organic strong base and/or a salt thereof is disclosed in Patent Document 2.

In Patent Document 3, a water-based primer coating material composition including a water-based polyolefin resin, a water-based acrylic resin and a water-based polyurethane resin as resin components is disclosed. The water-based polyolefin resin in this water-based primer coating material composition is modified with α, β-unsaturated dicarboxylic acid or anhydride thereof, has a saponification value of 10 to 60 mg KOH/g, and is preferably chlorinated. Specific examples of a primer using a water-based non-chlorinated polyolefin resin include an example in which a maleic anhydride modified ethylene-propylene copolymer is used in combination with a maleic anhydride modified polypropylene resin in the presence of an emulsifier to form a water-based resin.

However, these water-based primers had a problem that a bright coating film having an excellent appearance cannot be attained in the case of reapplying a base coating material including a bright pigment.

As a method for forming a multilayer coating film which can attain a bright coating film with an excellent appearance, Patent Document 4, Patent Document 5, and Patent Document 6 describe the so-called three-coat one-bake coating method, in which a solvent type primer is applied and baked under normal drying conditions, a first water-based base coating material and a second water-based base coating material are applied by a wet-on-wet method, and then a solvent type curing clear coating material is applied. In this step, since rapid baking is not performed and in application of each water-based base coating material, drying is previously performed prior to application of a coating material required in the next step, a phenomenon referred to as popping, in which pinholes are produced in a coating film, does not occur. However, a water-based primer is not applied in this step.

Patent Document 1: Japanese Kokai Publication 2001-139875

Patent Document 2: Japanese Kokai Publication 2004-002801

Patent Document 3: Japanese Kokai Publication H6-336568

Patent Document 4: Japanese Kokai Publication 2004-351389

Patent Document 5: Japanese Kokai Publication 2004-351390

Patent Document 6: Japanese Kokai Publication 2004-351391

### DISCLOSURE OF THE INVENTION

### Problems to be Solved by the Invention

In view of the above state of the art, it is an object of the present invention to provide a method for forming a bright coating film in which a water-based primer coating material composition using a polyolefin resin not including chlorine is applied and it is possible to achieve an improvement in appearance of a coating film to be obtained and shortening of a process step simultaneously.

### Means for Solving the Problems

The present invention is a method for forming a bright coating film, comprising the steps of:

(1) applying a water-based primer coating material composition to a substrate to form a water-based primer coating film;

(2) applying a water-based bright coating material (i) to the water-based primer coating film to form a first base coating film;

(3) applying a water-based bright coating material (ii) to the first base coating film to form a second base coating film;

(4) applying a high-solid clear coating material to the second base coating film to form a clear coating film; and

(5) heat-curing the water-based primer coating film, the first base coating film, the second base coating film, and the clear coating film simultaneously to form a cured coating film,

wherein the water-based primer coating material composition includes a water-based non-chlorinated polyolefin resin (A), a water-based polyurethane resin (B), a water-based epoxy resin (C), and an internally crosslinked acrylic particle emulsion (D), and an amount of an emulsifier is 2% by mass or less on a solid content equivalent basis with respect to 100% by mass of a total amount of the resin (A), the resin (B), the resin (C) and the emulsion (D),

wherein a content of the resin (A) is 15 to 60% by mass, a content of the resin (B) is 10 to 50% by mass, a content of the resin (C) is 20 to 50% by mass, and a content of the emulsion (D) is 5 to 20% by mass on a solid content equivalent basis with respect to 100% by mass of the total amount of the resin (A), the resin (B), the resin (C) and the emulsion (D), and

the resin (A) is a water-based polypropylene resin having a crystallinity of 35 to 55% and a weight average molecular weight of 50000 to 200000, and

wherein the high-solid clear coating material includes an acrylic resin.

The resin (A) is preferably obtained by use of a metallocene catalyst.

The resin (A) is preferably a water-based polypropylene resin which is converted to a water-based resin without using an emulsifier.

The resin (A) is preferably a modified polypropylene resin having a structure, in which a hydrophilic polymer is bound to an unsaturated organic acid derivative, as a modified portion.

The unsaturated organic acid derivative is preferably at least one compound selected from the group consisting of an unsaturated carboxylic acid, dicarboxylic acid anhydride, and dicarboxylic acid anhydride monoester.

The hydrophilic polymer is preferably a polyether resin having a polyalkylene structure.

Preferably, the emulsion (D) is obtained by emulsion polymerization of a monomer composition containing an ethylenic unsaturated monomer and a crosslinkable monomer, and a glass transition temperature of a non-crosslinked polymer obtained by polymerization of the ethylenic unsaturated monomer is 50 to 140° C., and a content of the crosslinkable monomer is 0.1 to 50% by mass with respect to 100% by mass of the monomer composition.

The high-solid clear coating material preferably contains an acrylic resin and polyisocyanate.

The acrylic resin is preferably formed by polymerization of a monomer composition containing at least one of (meth) acrylic monomers having a hydroxyl group represented by any one of the following formulae (1) to (3):

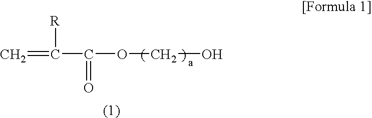

wherein “R” represents H (hydrogen) or CH₃ and “a” represents an integer of 3 or 4,

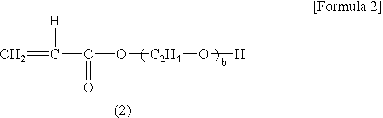

wherein “b” is 2 to 5 in the mean, and

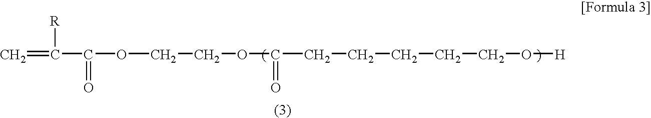

wherein “R” is the same as defined above.

The high-solid clear coating material preferably has a nonvolatile content of 52% by mass or more during application.

The high-solid clear coating material preferably has a nonvolatile content of 55% by mass or more during application.

The high-solid clear coating material preferably has an efflux viscosity of 15 to 25 seconds measured in accordance with JIS K 5600-2-2-3.

The following description will discuss the present invention in detail.

The method for forming a bright coating film of the present invention comprises the steps of: (1) forming a water-based primer coating film; (2) forming a first base coating film; (3) forming a second base coating film, (4) forming a clear coating film; and (5) forming a cured coating film.

Since the method for forming a bright coating film of the present invention is a method for forming the primer coating film, the first base coating film and the second base coating film from a water-based coating material, there is little concern about the effects on the environment. Furthermore, in the method for the present invention, a process step is simple and energy cost is low in that this method is a four-coat one-bake coating method, in which not only these coating films but also a high-solid clear coating film is formed in the so-called wet-on-wet form and heat-curing is performed just one time.

In the method for forming a bright coating film of the present invention, a water-based primer coating material composition containing a non-chlorinated polyolefin is used, but conventionally, when the non-chlorinated polyolefin has been used, it is extremely difficult to achieve an adhesion property and gasohol resistance simultaneously in the obtained multilayer coating film. On the other hand, in the present invention, these performances can be achieved simultaneously since a water-based polypropylene resin, in which the ranges of crystallinity and a weight average molecular weight are limited to the extent described above, is used as a non-chlorinated polyolefin in the water-based primer coating material composition. Further, the inhibition of peeling of the obtained multilayer coating film upon washing a car by high pressure cleaning and humidity resistance can be simultaneously achieved. Preferably, the above-mentioned water-based primer coating material composition uses only resin not containing chlorine as a resin component.

Since the water-based primer coating film from a specific water-based primer coating material composition is further formed in the method for forming a bright coating film of the present invention, this method allows for the formation of a coating film having excellent brightness and an excellent appearance, which cannot be obtained by use of a conventional water-based primer coating film.

The mechanism of such an excellent effect exerted by the above-mentioned water-based primer coating material composition is as follows.

That is, in conventional water-based primer coating material compositions, since an emulsifier is used in order to convert a resin to be used to a water-based resin, a thin emulsifier layer is formed on a part of the surface of a coating film upon coating and hydrophobic groups of the emulsifier in this emulsifier layer are oriented on the surface side of the coating film. When a coating material containing a bright pigment is applied to such a coating film, since an applied coating material is rejected or moved by the above-mentioned hydrophobic groups on the surface side of the coating film, the surface of the coating film to be obtained is not uniform and the bright pigment is not regularly oriented, and therefore the surface of the coating film is not smooth and a bright appearance cannot be attained. On the other hand, since the water-based primer coating material composition of the present invention contains the emulsifier in a small amount with respect to the total amount of all resins as described above, the emulsifier layer is not formed on the surface of a primer coating film when the water-based primer coating material composition is applied, and as a result, the surface of the coating film can be smoothed and the bright pigment can be regularly oriented. Thus, a favorable coating film appearance can be attained.

Hereinafter, the steps of the present invention will be described in detail.

### [Step 1]

The step (1) in the present invention is a step of applying a water-based primer coating material composition to a substrate to form a water-based primer coating film

Application of the water-based primer coating material composition is not particularly limited, and can be performed by applying the water-based primer coating material composition by spray coating such as air spray and airless spray, bell coating, disk coating, curtain coating, shower coating, brush coating or the like, and then drying the resulting primer coating film. As the above-mentioned drying, either natural drying or forced drying may be employed, but the forced drying is preferable from the viewpoint of coating efficiency. As the forced drying, any one of, for example, hot air drying, near-infrared drying, electromagnetic wave drying and the like may be employed. A drying temperature is selected in a temperature range in which thermal deformation of a substrate does not occur, and a material temperature is preferably 40 to 100° C., and more preferably 90° C. or lower. Further, a drying time generally depends on the drying temperature and an air velocity in a drying oven and can be appropriately set in consideration of energy efficiency, but the drying time is preferably 1 to 5 minutes.

A dried film thickness of the water-based primer coating material composition is preferably 5 to 20 μm, and more preferably 10 to 15 μm. When the dried film thickness is less than 5 μm, the film is so thin that a continuous uniform film tends not to be obtained. When the dried film thickness is more than 20 μm, durability and the like tend to deteriorate.

Examples of the substrate include: polyolefin such as polypropylene (PP) and polyethylene (PE); and plastic materials such as acrylonitrile styrene (AS), acrylonitrile butadiene styrene (ABS), polyphenylene oxide (PPO), polyvinyl chloride (PVC), polyurethane (PU), and polycarbonate (PC); and molded articles thereof.

The water-based primer coating material composition includes, in specific composition, a water-based non-chlorinated polyolefin resin (A), a water-based polyurethane resin (B), a water-based epoxy resin (C) and an internally crosslinked acrylic particle emulsion (D), wherein the resin (A) is a water-based polypropylene resin having a crystallinity of 35 to 55% and a weight average molecular weight of 50000 to 200000.

In the water-based primer coating material composition, as described above, the amount of the emulsifier is 2% by mass or less and preferably 1% by mass or less on the solid content equivalent basis with respect to 100% by mass of the total amount of the resin (A), the resin (B), the resin (C), and the emulsion (D).

Thus, the emulsifier layer is not formed on the surface of the coating film when the water-based primer coating material composition is applied. As the result of this, when a coating material containing a bright pigment is applied to the obtained coating film, the arrangement of the bright pigment is not disturbed, and therefore a coating film having excellent brightness and an excellent coating appearance can be attained. By using a resin of a self-emulsifying type as required for each resin in order to limit the above-mentioned amount of the emulsifier to such an extent, the amount of the emulsifier can be reduced.

The resin (A) is a water-based non-chlorinated polyolefin resin. The resin (A) is a component forming a matrix of a coating film and can be melted by heat.

The content of the resin (A) is 15 to 60% by mass on the solid content equivalent basis with respect to 100% by mass of the total amount of the resin (A), the resin (B), the resin (C) and the emulsion (D), and preferably 20 to 40% by mass. When this content is less than 15% by mass, poor adhesion to a substrate due to insufficient adhesion points may occur. When the content is more than 60% by mass, poor adhesion to a top coat (base) due to a difference between polarities may occur.

The resin (A) has crystallinity of 35 to 55%. When the above-mentioned crystallinity is less than 35%, a coating film may have the low gasohol resistance and the low ability of a car's coating film to be washed with a high pressure jet, and may have insufficient adhesion property. When the crystallinity is higher than 55%, a melting property may be deteriorated and the adhesion property to a substrate may be low.

Since both a crystalline portion and an amorphous portion exist moderately in a structure of the resin (A), as described above, a melting point can be controlled while preserving crystal sites and the adhesion property to a material and the gasohol resistance can be simultaneously achieved at a higher order.

In the present specification, a measuring method for the crystallinity is as follows.

### (Crystallinity)

The stereoregularity (mmmm) of polypropylene is measured by ¹³C-NMR spectrometry using an NMR apparatus (produced by JEOL Ltd., 400 MHz). Samples 350 to 500 mg are completely dissolved in about 2.2 mL of o-dichlorobenzene in a 10 mmφNMR sample tube. Next, about 0.2 mL of benzene deuteride is added as a lock solvent, and after homogenization of the resulting mixture, the stereoregularity is measured at 130° C. by a proton complete decoupling method. As the measuring conditions, a flip angle is 90° and a pulse interval is 5T₁ or more (T₁ is the longest time of spin-lattice relaxation times of an methyl group). In propylene polymers, since the spin-lattice relaxation times of a methylene group and a methyne group are shorter than that of a methyl group, the recovery of magnetization of all carbons is 99% or more under these conditions. The stereoregularity is measured by integrating spectra for 20 hours or more.

As for chemical shifts, the chemical shift of a peak based on a methyl group which is a third unit in a propylene unit five linkages having the same absolute configurations of a methyl branch, that is, represented by mmmm among 10 species of pentads (mmmm, mmmr, rmmr, mmrr, mmrm, rmrr, rmrm, rrrr, rrrm, and mrrm) in a propylene unit linkage portion including head to tail bonds is set at 21.8 ppm, and on the basis of this chemical shift, the chemical shifts of other carbon peaks are determined. In accordance with this basis, in the case of other propylene unit five linkages, the chemical shift of a peak based on a methyl group which is a third unit are generally as follows. That is, mmmr: 21.5 to 21.7 ppm, rmmr: 21.3 to 21.5 ppm, mmrr: 21.0 to 21.1 ppm, mmrm and rmrr: 20.8 to 21.0 ppm, rmrm: 20.6 to 20.8 ppm, rrrr: 20.3 to 20.5 ppm, rrrm: 20.1 to 20.3 ppm, and mrrm: 19.9 to 20.1 ppm.

With respect to this polypropylene main chain, the ratio (S₁/S) of an area S₁ of the peak in which 21.8 ppm is a peak top to the total area S of the peaks belonging to the pentads appearing in a range of 19.8 ppm to 22.2 ppm when the chemical shift of a peak top of a peak belonging to the pentad represented by mmmm is set at 21.8 ppm, that is, all pentads of mmmm, mmmr, rmmr, mmrr, mmrm, rmrr, rmrm, rrrr, rrrm, and mrrm is defined as a crystallinity.

In addition, in the present specification, since the crystallinity is measured according to the method described above, the crystallinity of a copolymer of propylene and another monomer means the crystallinity of a polypropylene segment in a resin.

The weight average molecular weight of the resin (A) is 50000 to 200000. When the weight average molecular weight is less than 50000, the adhesion property of a coating film is deteriorated due to reduction in the cohesive force of the coating film, and the gasohol resistance, the humidity resistance, and the ability of a car's coating film to be washed with a high pressure jet may be deteriorated. When the weight average molecular weight is more than 200000, it is difficult to form a water-based resin and this interferes with production of a water-based resin.

In this specification, a measuring method for the above-mentioned weight average molecular weight is as follows.

### (Weight Average Molecular Weight)

First, 20 mg of a sample is put into a 30-mL vial bottle, and 20 g of o-dichlorobenzene containing 0.04% by mass of BHT as a stabilizer is added. The sample is dissolved using an oil bath heated to 135° C., and then thermally filtrated with a PTFE (polytetrafluoroethylene) filter with a bore size of 3 μm to prepare a sample solution having a polymer concentration of 0.1% by mass. Next, the weight average molecular weight is measured by a gel permeation chromatography (GPC) method using GPC150CV produced by Waters corporation, equipped with TSKgel GM H-HT (30 cm×4) as a column and a refractive index (RI) detector. As measuring conditions, the injection amount of the sample solution: 500 μl, a column temperature: 135° C., a solvent: o-dichlorobenzene, and an eluent flow rate: 1.0 mL/min are employed.

On the determination of a molecular weight, commercially available monodispersed polystyrene is used as a standard sample to derive the molecular weight on this polystyrene standard sample equivalent basis.

Preferably, the resin (A) has a melting point of 50 to 100° C. When the melting point is less than 50° C., an amorphous portion increases, the gasohol resistance, the humidity resistance, and the ability of a car's coating film to be washed with a high pressure jet may be deteriorated. When the melting point is more than 100° C., a melting property may be deteriorated and the adhesion property to a material may be low.

In the present specification, a measuring method for the melting point (° C.) of the resin (A) is as follows.

### (Measuring Method for Melting Point)

Values measured according to the following steps using a differential scanning calorimeter (DSC) (thermal analyzer SSC5200 produced by Seiko Instruments Inc.) are used. That is, in the step of raising temperature at a temperature raising rate of 10° C./min from 20° C. to 150° C. (step 1), the step of lowering temperature at a temperature lowering rate of 10° C./min from 150° C. to −50° C. (step 2), and the step of raising temperature at a temperature raising rate of 10° C./min from −50° C. to 150° C. (step 3), temperature indicated by an arrow of a chart of FIG. 1 in raising temperature of the step 3 is selected as a melting point.

The water-based non-chlorinated polypropylene resin is a water-based polypropylene resin which is not chlorinated. The present invention uses a water-based non-chlorinated polypropylene resin, but it has an excellent adhesion property in baking and drying at low temperatures. Examples of the water-based non-chlorinated polypropylene resin include a monopolymer of propylene and a copolymer of propylene and a monomer (ethylene, etc.) which can be copolymerized with propylene and does not contain chlorine.

In the above-mentioned polypropylene resin, examples of constituent monomers other than propylene include monoolefins or diolefins having 2 or 4 to 20 carbon atoms such as butene, pentene, hexene, octene, decene, butadiene, hexadiene, octadiene, cyclobutene, cyclopentene, cyclohexene, norbornene, norbornadiene, styrene and derivatives thereof. In the present specification, the contents of monomers forming a resin can be determined from the amounts of monomers used for producing the resin.

The resin (A) is preferably a polypropylene resin in which 90% by mass or more of a constituent monomer is propylene. When the ratio of propylene is less than 90% by mass in the polypropylene resin, a crystallinity segment of a resin may be small.

The resin (A) is preferably obtained by using a metallocene catalyst. This means that the metallocene catalyst can generally control microtacticity by ligand design, that is, the resulting polypropylene main chain contains an isotactic block having a chain length which can be crystallized. The existence of the isotactic block means that blocks including sequences having disordered stereospecificity exist simultaneously in the main chain. That is, blocks having the crystallinity and amorphous blocks coexist in the polypropylene main chain formed by polymerization using the metallocene catalyst, and the block having the crystallinity is formed of the isotactic block having a relatively long average chain length and has a unique structure that is a highly isotactic structure. With such a characteristic, when polyolefin formed by polymerization using the metallocene catalyst is used for a coating material composition, it is possible to further improve an adhesion property to the substrate. As the above-mentioned metallocene catalyst, publicly known catalysts can be used, and examples of the catalysts include a catalyst described in Japanese Kokai Publication 2004-115712 (paragraphs [0021] to [0052]).

The resin (A) is preferably a substance (hereinafter, also referred to as a modified polypropylene resin) having a structure in which a hydrophilic polymer is bound to an unsaturated organic acid derivative as a modified portion.

Since the resin (A) can be self-emulsified, generally called, by having such a modified portion, it can be converted to a water-based resin without using an emulsifier. Furthermore, since this modified portion is chemically bound to a resin structure of polyolefin, the resin (A) does not form the emulsifier layer described above when a water-based primer coating material composition to be obtained is applied to the resin (A). Furthermore, since the water-based primer coating material composition of the present invention has a low content of the emulsifier as described above, when a coating material containing a bright pigment is applied to the obtained coating film, the arrangement of the bright pigment is not disturbed. Thus, the water-based primer coating material composition of the present can attain a coating film having excellent brightness and coating appearance.

The resin (A) can be self-emulsified by further having a structure derived from a hydrophilic polymer as a modified portion even though an addition ratio of the unsaturated organic acid derivative is low and an acid value is small. As the result, the resin (A) can be converted to a water-based resin without using an emulsifier.

The unsaturated organic acid derivatives are as follows: unsaturated organic acids, acid anhydrides thereof or esterified products thereof. Examples of the unsaturated organic acid derivatives include an unsaturated carboxylic acid, dicarboxylic acid anhydride, and dicarboxylic acid anhydride monoester.

Examples of the substance modified with the unsaturated organic acid derivative (hereinafter, such a propylene resin is referred to as an “acid modified polypropylene resin”) include substances modified by grafting an unsaturated carboxylic acid having 3 to 25 carbon atoms, acid anhydride thereof or monoester of this acid anhydride to the main chain of the polypropylene resin. This graft reaction can be performed by a normal method using a radical generator.

Examples of the unsaturated organic acid derivative to be grafted include maleic acid, fumaric acid, itaconic acid, tetrahydrophthalic acid, citraconic acid, crotonic acid, allylsuccinic acid, mesaconic acid, aconitic acid, acid anhydrides thereof and monoester of these acid anhydrides, and among others, maleic acid and maleic anhydride are preferred.

The ratio of addition of the unsaturated organic acid derivative in the modified polypropylene resin (content of the unsaturated organic acid derivative in the modified polypropylene resin) is 1 to 10% by mass, and preferably 1.5 to 5% by mass. When this ratio of addition is less than 1% by mass, a dispersed particle of a water-based primer coating material composition to be obtained has a large particle diameter and the dispersion stability of the particles tends to be poor, and when the ratio of addition is more than 10% by mass, the water resistance of a coating film tends to be deteriorated. This ratio of addition can be measured by comparing absorption intensity of a carbonyl group with a calibration curve of a carbonyl group which has been prepared based on samples having known ratios of addition (contents) by infrared spectroscopic analysis.

Examples of the hydrophilic polymer include poly(meth)acrylic resins, polyvinyl alcohol resins, polyvinylpyrolidone resins, polyether resins and the like. As the hydrophilic polymer, polyether resins are preferable in that the amount of a modified portion is small and a resin which can be self-emulsified is obtained, and polyether resins having a polyalkylene structure are more preferable.

The hydrophilic polymer may have a functional group (hereinafter, these functional groups may be collectively called a “reactive group”) such as a carboxyl group, a dicarboxylic anhydride group, a dicarboxylic ester group, a hydroxyl group, an amino group, an epoxy group, an isocyanate group, and a silyl group.

The above-mentioned modified polypropylene resin can be prepared by adding the unsaturated organic acid described above to the polypropylene resin and further binding the hydrophilic polymer to this addition product.

As a method for adding the unsaturated organic acid derivative, a method for performing the graft reaction by subjecting a resin to the decomposition conditions of a radical generator in the presence of the radical generator is common, and examples of this method include a method in which a polypropylene main chain is dissolved in an organic solvent, and to this, the unsaturated carboxylic acid, acid anhydride thereof or an esterified product thereof and the radical generator are added, and the resulting mixture is heated during stirring to perform addition, and a method in which components are supplied to an extruder to perform addition while the components are heated and kneaded.

The molar ratio of the radical generator to be used to the unsaturated organic acid derivative (ratio of the radical generator to the unsaturated organic acid derivative) is usually 1/100 to 3/5, preferably 1/20 to 1/2, and the reaction temperature is not particularly limited, but it is usually 50° C. or higher, preferably 80 to 200° C. The reaction time is usually 2 to 10 hours.

The radical generator used for the graft reaction can be appropriately selected from common radical generators to be used, and includes, for example, organic peroxides and the like. The organic peroxide is not particularly limited, but di(t-butyl)peroxide, dicumyl peroxide, and tert-butyl peroxyisopropylmonocarbonate are preferable.

Examples of an organic solvent used in performing a graft reaction include aromatic hydrocarbons, aliphatic hydrocarbons, halogenated hydrocarbons and the like, and among these solvents, aromatic hydrocarbons and halogenated hydrocarbons are preferable, and toluene, xylene, and chlorbenzene are particularly preferable.

When a modified polypropylene resin having an esterified product of unsaturated carboxylic acid as a modified component is produced, it can also be produced by a method for grafting unsaturated dicarboxylic monoester onto a polypropylene main chain, or a method for grafting unsaturated dicarboxylic acid or anhydride thereof onto a polypropylene main chain, and then esterifying one of carboxyl groups with aliphatic alcohol or monoesterifying an acid anhydride group.

Examples of the method for binding the hydrophilic polymer to the unsaturated organic acid derivative portion include (1) a method for polymerizing a hydrophilic radically polymerizable monomer or a hydrophilic ring-opening polymerizable monomer in the presence of an acid modified polypropylene resin, and (2) a method for binding a hydrophilic polymer previously prepared to an acid modified polypropylene resin.

Examples of the above-mentioned method (1) include (1-1) a method in which in the presence of the above-mentioned acid modified polypropylene resin and a radical polymerization initiator, a hydrophilic radically polymerizable monomer or a hydrophilic ring-opening polymerizable monomer is polymerized and thereby a hydrophilic polymer is formed and is bound to the acid modified polypropylene resin, and (1-2) a method in which a hydrophilic ring-opening polymerizable monomer or a hydrophobic ring-opening polymerizable monomer is polymerized using an end group of the unsaturated organic acid derivative added to the acid modified polypropylene resin as an initiation end.

Examples of the above-mentioned hydrophilic radically polymerizable monomers include (meth)acrylic acid, hydroxyethyl (meth)acrylate, methoxypolyethylene glycol (meth)acrylate, dimethylaminoethyl (meth)acrylate, quaternary dimethylaminoethyl (meth)acrylate, vinylpyrrolidone and the like.

In the above-mentioned method (1-1), the hydrophilic radically polymerizable monomer may be copolymerized with a hydrophobic monomer.

Examples of the above-mentioned hydrophobic monomer include: (meth)acrylate ester compounds such as methyl (meth)acrylate, and butyl (meth)acrylate; vinyl acetate; and the like. When the hydrophobic monomer is polymerized, the resulting polymer can be modified to a water-based polymer by publicly known methods such as hydrolysis or saponification after a polymerization reaction.

Examples of the above-mentioned hydrophilic ring-opening polymerizable monomer include ethylene oxide, propylene oxide, ethylene imine, and the like. Examples of the above-mentioned hydrophobic ring-opening polymerizable monomer include trimethyleneoxide, tetrahydrofuran, β-propiolactone, γ-butylolactone, ε-caprolactone and the like. Further, when the hydrophobic ring-opening polymerizable monomer is polymerized, the resulting polymer can be modified to a water-based polymer as described above.

Examples of the method (2) include (2-1) a method in which the hydrophilic polymer is prepared so as to have an unsaturated double bond and further the hydrophilic polymer is graft-polymerized with the acid modified polypropylene resin using a radical polymerization initiator, and (2-2) a method in which a hydrophilic polymer having a reactive group at the end is prepared and then the hydrophilic polymer is bound to the acid modified polypropylene resin.

The hydrophilic polymer having an unsaturated double bond can be prepared by polymerizing a hydrophilic radically polymerizable monomer in the presence of the radical polymerization initiator. The above-mentioned hydrophilic polymer having a reactive group at the end can be prepared by performing the polymerization using a compound having a reactive group as a polymerization initiator or a chain transfer agent.

Examples of the above-mentioned polymerization initiator include organic peroxides such as ammonium persulfate and di(butylperoxy)cyclohexane, and azonitrile such as azobisbutylonitrile. Examples of the above-mentioned chain transfer agent include alcohols such as methanol and ethanol.

The above-mentioned methods (1) and (2) can be performed by publicly known reaction methods such as a solution-modifying method and a melting/modifying method. Reaction conditions can be appropriately selected in accordance with a monomer to be used, the kind of a desired resin, or the like.

The resin (A) can be converted to a water-based resin without using an emulsifier as described above. The resin (A) is preferably a water-based polypropylene resin which is converted to a water-based resin without using an emulsifier.

The conversion of the resin (A) to a water-based resin can be performed by a method in which an organic solvent solution of the resin (A) is prepared, an acid group such as a carboxyl group in the resin (A) is neutralized with a neutralizer such as excessive amine, and deionized water is added dropwise to the solution of the resin (A) while forcedly stirred to emulsify the solution of the resin (A) and then the solvent is removed by reducing a system pressure. Further, there is also a method in which a solution formed by dissolving acid anhydride modified polyolefin in the heated solvent is added dropwise to a hot deionized water while forcedly stirred, in which a neutralizer such as amine has been dissolved, and then the solvent is removed by reducing a system pressure.

Examples of the organic solvent upon the conversion of the resin to a water-based resin include alcohol, ketone, ester, aromatic hydrocarbon, aliphatic hydrocarbon, alicyclic hydrocarbon, halogenated hydrocarbon, and solvents containing a functional group such as an amide group or a sulfonyl group. Among these solvents, alcohol and ketone are preferable.

The water-based primer coating material composition in the present invention includes the water-based polyurethane resin (B). By using the above-mentioned resin (B), excellent solvent resistance and gasohol resistance can be attained in the obtained multilayer coating film. The resin (B) is a component forming a matrix of a coating film.

The content of the resin (B) is 10 to 50% by mass on the solid content equivalent basis with respect to 100% by mass of the total amount of the resin (A), the resin (B), the resin (C) and the emulsion (D). When this content is less than to 10% by mass, poor gasohol resistance may occur. When it is more than 50% by mass, poor adhesion performance may occur by high pressure car wash.

Examples of the resin (B) include an urethane dispersion prepared by adding deionized water to an urethane prepolymer, which is obtained by reacting a polyfunctional isocyanate compound, polyol having two or more hydroxyl groups in a molecule, and a hydrophilizing material having both a hydroxyl group and a carboxylic acid group such as dimethylolpropanediol or dimethylolbutanediol in a state of excessive isocyanate groups in the presence of a catalyst such as dibutyl tin dilaurate and then neutralizing a carboxylic acid with an organic base such as amine or an inorganic base such as potassium hydroxide, and sodium hydroxide, to convert to a water-based prepolymer, and increasing a molecular weight of the prepolymer with a chain extender; an urethane dispersion prepared by synthesizing an urethane prepolymer not containing a carboxylic acid, extending a chain with diol or diamine, having a hydrophilic group such as carboxylic acid, sulfonic acid and ethylene glycol, neutralizing with the above-mentioned basic substance to convert a resin to a water-based resin, and further increasing a molecular weight of the resin using a chain extender as required; and an urethane dispersion obtained by using an emulsifier together as required.

Examples of the above-mentioned polyfunctional isocyanate compound include polyfunctional isocyanate compounds such as diisocyanate compounds, for example, 1,6-hexanediisocyanate, lysine diisocyanate, isophorone diisocyanate, cyclohexane-1,4-diisocyanate, xylylene diisocyanate, 2,4-trilene diisocyanate and 2,6-trilene diisocyanate, and adducts, biurets and isocyanurates thereof.

Examples of the above-mentioned polyols include polyester polyols, polyether polyols, polycarbonate polyols, and the like.

Examples of the above-mentioned chain extender include low molecular weight diol compounds such as ethylene glycol, propylene glycol, 1,4-butanediol, neopentyl glycol, furanedimethanol, diethylene glycol, triethylene glycol and tetraethylene glycol, and polyetherdiol compounds prepared by polymerization by addition of ethylene oxide, propylene oxide, tetrahydrofuran or the like to these diol compounds; polyesterdiols having a hydroxyl group at an end, which are obtained from the above-mentioned low molecular weight diol compounds, dicarboxylic acid such as succinic acid (anhydride), adipic acid and phthalic acid (anhydride), and anhydrides thereof; polyhydric alcohols such as trimethylol ethane and trimethylol propane; aminoalcohols such as monoethanolamine, diethanolamine and triethanolamine; diamine compounds such as ethylenediamine, propylenediamine, butylenediamine, hexamethylene diamine, phenylenediamine, toluenediamine, xylylenediamine and isophorone diamine; water; ammonia; hydrazine; dibasic acid hydrazide; and the like.

As the resin (B), commercially available urethane dispersions can also be used. The above-mentioned commercially available urethane dispersion is not particularly limited, and examples of the urethane dispersion include SUPERFLEX 150, SUPERFLEX 420, SUPERFLEX 460 (all produced by DAI-ICHI KOGYO SEIYAKU Co., Ltd.), Bayhydrol VP LS2952 (produced by Sumika Bayer Urethane Co., Ltd.), VONDIC 2260, VONDIC 2220, HYDRAN WLS210, HYDRAN WLS213 (all produced by DIC Corporation), NeoRez R9603 (produced by Avecia Ltd.), and the like.

The water-based primer coating material composition includes the water-based epoxy resin (C). By using the above-mentioned resin (C), water resistance and humidity resistance can be improved.

The content of the resin (C) is 20 to 50% by mass on the solid content equivalent basis with respect to 100% by mass of the total amount of the resin (A), the resin (B), the resin (C) and the emulsion (D). When the content of the resin (C) is less than 20% by mass, poor water resistance and poor humidity resistance due to the reduction of a gel fraction may occur. When the content is more than 50% by mass, poor water resistance and poor humidity resistance due to poor film formation may occur.

As the water-based epoxy resin (C), an epoxy resin which is a water-based resin having one or more epoxy groups in a molecule and is publicly known in this technical field can be used. Examples of this epoxy resin (C) include Denacol EM-150 (produced by Nagase Chemicals Ltd.), EPIREZ 6006W70 and 5003W55 (all produced by Japan Epoxy Resins Co., Ltd.), and WEX-5100 (produced by Tohto Kasei Co., Ltd), which is prepared by emulsifying a novolac epoxy resin obtained by adding epichlorohydrin to a phenol novolac resin with an emulsifier. Examples of this epoxy resin (C) further include Denacol EM-101, EM-103 (all produced by Nagase Chemicals Ltd.), and EPIREZ 3510W60, 3515W6, 3522W60, 3540WY55 (all produced by Japan Epoxy Resins Co., Ltd.), which is prepared by forcedly emulsifying, with an emulsifier, a bisphenol type epoxy resin obtained by adding epichlorohydrin to bisphenol. Further, examples of alkyl type epoxy resin formed by adding epichlorohydrin to polyols such as sorbitol, pentaerythritol and glycerin include Denacol EX-611, EX-614, EX-411, EX-313 (all produced by Nagase Chemicals Ltd.), and the like.

The water-based primer coating material composition includes the internally crosslinked acrylic particle emulsion (D). By using the above-mentioned emulsion (D), it is possible to well inhibit the peeling of a multilayer coating film upon washing a car by high pressure car wash.

The content of the emulsion (D) is 5 to 20% by mass on the solid content equivalent basis with respect to 100% by mass of the total amount of the resin (A), the resin (B), the resin (C) and the emulsion (D). When this content is less than to 5% by mass, poor ability of a car's coating film to be washed with a high pressure jet due to insufficient hardness may occur. When the content is more than 20% by mass, poor water resistance and poor humidity resistance due to poor film formation may occur.

The emulsion (D) is an emulsion including an acrylic resin having a crosslinked structure. The emulsion (D) is not particularly limited, and examples of the emulsion (D) include emulsions including an acrylic resin having a crosslinked structure obtained by using an ethylenic unsaturated monomer and a crosslinkable monomer. The average particle diameter of the emulsion (D) is preferably 0.1 to 1.0 μm.

The above-mentioned ethylenic unsaturated monomer is not particularly limited, and examples of the ethylenic unsaturated monomer include: alkyl esters of acrylic acid or methacrylic acid such as methyl (meth)acrylate, ethyl (meth)acrylate, n-butyl (meth)acrylate, isobutyl (meth)acrylate, and 2-ethylhexyl (meth)acrylate; styrene, α-methylstyrene, vinyl toluene, t-butylstyrene, ethylene, propylene, vinyl acetate, vinyl propionate, acrylonitrile, methacrylonitrile, dimethylaminoethyl (meth)acrylate and the like. These monomers may be used singly or in combination of two or more kinds.

The above-mentioned crosslinkable monomer is not particularly limited, and examples of the crosslinkable monomer include monomers having two or more radically polymerizable ethylenic unsaturated bonds in a molecule, and monomers containing two kinds of ethylenic unsaturated groups, respectively, each of which carries one of groups capable of reacting with each other.

The above-mentioned monomers having two or more radically polymerizable ethylenic unsaturated bonds in a molecule, which can be used for the production of the emulsion (D), is not particularly limited, and examples of the monomers include: polymerizable unsaturated monocarboxylic acid esters of polyhydric alcohol such as ethyleneglycol diacrylate, ethyleneglycol dimethacrylate, triethyleneglycol dimethacrylate, tetraethyleneglycol dimethacrylate, 1,3-butyleneglycol dimethacrylate, trimethylolpropane triacrylate, trimethylolpropane trimethacrylate, 1,4-butanediol diacrylate, neopentylglycol diacrylate, neopentylglycol dimethacrylate, 1,6-hexanediol diacrylate, pentaerythritol diacrylate, pentaerythritol triacrylate, pentaerythritol tetraacrylate, pentaerythritol dimethacrylate, pentaerythritol trimethacrylate, pentaerythritol tetramethacrylate, glycerol dimethacrylate, glycerol diacrylate, glycerol allyloxy dimethacrylate, 1,1,1-trishydroxymethylethane diacrylate, 1,1,1-trishydroxymethylethane triacrylate, 1,1,1-trishydroxymethylethane dimethacrylate, 1,1,1-trishydroxymethylethane trimethacrylate, 1,1,1-trishydroxymethylpropane diacrylate, 1,1,1-trishydroxymethylpropane triacrylate, 1,1,1-trishydroxymethylpropane dimethacrylate and 1,1,1-trishydroxymethylpropane trimethacrylate; polymerizable unsaturated alcohol esters of polybasic acid such as triallyl cyanurate, triallyl isocyanurate, triallyl trimelitate, diallyl terephthalate and diallyl phthalate; aromatic compounds substituted by two or more vinyl groups such as divinylbenzene; and the like. These monomers may be used singly or in combination of two or more kinds.

A combination of functional groups capable of reacting with each other, which exist in the above-mentioned monomers having two kinds of ethylenic unsaturated groups, respectively, each of which carries one of groups capable of reacting with each other, is not particularly limited, and examples of these combinations include combinations of an epoxy group and a carboxyl group, an amine group and a carbonyl group, an epoxy group and a carboxylic anhydride group, an amine group and a carboxylic acid chloride, an alkyleneimine group and a carbonyl group, an organoalkoxysilane group and a carboxyl group, a hydroxyl group and an isocyanate glycidyl acrylate group, and the like. Among these combinations, the combination of an epoxy group and a carboxyl group is more preferable.

Examples of the above-mentioned monomers having two kinds of ethylenic unsaturated groups of the above combination of an epoxy group and a carboxyl group include a combination of an epoxy group-containing ethylenic unsaturated monomer such as glycidyl methacrylate, a carboxyl group-containing ethylenic unsaturated monomer such as acrylic acid, methacrylic acid and crotonic acid, and the like.

It is preferable that the emulsion (D) is obtained by emulsion polymerization of a monomer composition including an ethylenic unsaturated monomer and a crosslinkable monomer, and the glass transition temperature of a non-crosslinked polymer obtained by polymerization of the ethylenic unsaturated monomer is 50 to 140° C., and the content of the crosslinkable monomer is 0.1 to 50% by mass with respect to 100% by mass of the monomer composition (100% by mass of the total amount of the ethylenic unsaturated monomer and crosslinkable monomer). In this case, an adhesion property to a material and gasohol resistance can be achieved simultaneously and the inhibition of peeling of the multilayer coating film upon washing a car by high pressure cleaning and humidity resistance can also be achieved simultaneously.

In the above description, when the glass transition temperature (Tg) of a non-crosslinked polymer is lower than 50° C., the hardness of a particle is low and an effect of curing a coating film is small, and therefore the ability of a car's coating film to be washed with a high pressure jet may be deteriorated. Also, when the content of the crosslinkable monomer is less than 0.1% by mass, the crosslinking degree of particles is low, and consequently the strength and the hardness of a particle is low and an effect of curing a coating film is small, and therefore the ability of a car's coating film to be washed with a high pressure jet may be deteriorated.

In the above description, when the Tg of a non-crosslinked polymer is higher than 140° C., a crosslinked particle is too hard like stones, and therefore a coating film is too hard and is susceptible to cohesive failure.

In the present specification, the glass transition temperature (Tg) is a value derived from a chart in raising temperature of the step 3 obtained by the same method as the above-mentioned measuring method for melting point. That is, a temperature indicated by an arrow of a chart shown in FIG. 2 is selected as a Tg.

The water-based primer coating material composition can also be appropriately blended with other water-based resins as required in addition to the above-mentioned essential respective components (A), (B), (C), and (D). Examples of other water-based resins include a water-based acrylic resin and the like. Examples of these water-based resins include substances to be blended for the purpose of using as a pigment dispersant described later.

The water-based primer coating material composition can be blended with other substances which are usually added as a coating material, for example, a pigment, a neutralizer, a stabilizer, a thickener, an antifoaming agent, a surface control agent, a leveling agent, a pigment dispersant, an ultraviolet absorber, an antioxidant, inorganic fillers such as silica, conductive carbon, conductive fillers, conductive filling materials such as metal powder, an organic modifier, a plasticizer and the like as required.

Examples of the above-mentioned thickener include nonionic associated urethane thickener, alkali-swelling thickener, bentonite which is an inorganic intercalation compound, and the like.

Examples of the above-mentioned pigment include: color pigments such as inorganic pigments, for example, titanium oxide, carbon black, iron oxide, chromium oxide and iron blue, and organic pigments, for example, azo pigments, anthracene pigments, perylene pigments, quinacridone pigments, indigo pigments and phthalocyanine pigments; extender pigments such as talc and precipitated barium; conductive pigments such as conductive carbon and whisker coated with antimony-doped tin oxide; and non-colored or colored bright materials made of metal such as metals or alloys of aluminum, copper, zinc, nickel, tin or aluminum oxide.

Examples of the above-mentioned pigment dispersant include: water-based acrylic resins; acid block copolymers such as BYK-190 produced by BYK Japan KK and the like; styrene-maleic acid copolymers; acetylene-diol derivatives such as Surfynol GA and Surfynol T324 all produced by Air Products and Chemicals, Inc.; and water-based carboxymethylcellulose acetate butylate such as CMCAB-641-0.5 produced by Eastman Chemical Company. By using these pigment dispersants, stable pigment paste can be prepared. Examples of the above-mentioned antifoaming agent include Surfonol 104PA and Surfonol 440 all produced by Air Products and Chemicals, Inc.

The water-based primer coating material composition is produced by mixing (A) to (D) described above and other components used as required. Particularly when a water-based primer coating material composition including a pigment is produced, a method for producing the water-based primer coating material composition by preparing pigment dispersed paste including a pigment and a pigment dispersant in advance has high production efficiency.

### [Step 2]

In the present invention, the step (2) is a step of applying a water-based bright coating material (i) to the water-based primer coating film described above to form the first base coating film.

Application of the above-mentioned coating material (i) is not particularly limited, and it can be performed by applying and drying the coating material (i) in the same way as in the step (1) described above, and among others, it is preferable to perform spray coating.

In the spray coating, a bell type coating machine of a rotary atomizing type and a coating machine of an air-atomizing type can be used as a spray gun.

Drying in the step (2) is preferably performed at room temperature for 1 to 3 minutes. After this drying (setting), the water-based bright coating material (ii) can be applied.

The dried film thickness of the first base coating film is preferably 5 to 15 μm. When the dried film thickness is less than 5 μm, the coating film is so thin that a continuous uniform film tends not to be obtained. When the dried film thickness is more than 15 μm, water resistance and the like tend to deteriorate.

The coating material (i) includes a water-based resin, a bright pigment and water. In the coating material (i), generally, the water-based resin is dispersed in water and the bright pigment is dissolved or dispersed in water. The coating material (i) may include a hydrophilic organic solvent as a solvent, but the content of water is preferably 51 to 100% by mass of all solvent.

The water-based resin composes a vehicle in a coating film to be obtained. In the present specification, the water-based resin contains a water-soluble resin, a water-dispersible resin, and an emulsion resin.

The water-based resin is not particularly limited as long as it can be dispersed or dissolved in water. Among these water-based resins, examples of the resin forming a matrix include an acrylic resin and a polyurethane resin, and the acrylic resin and the polyurethane resin are preferable.

Examples of the crosslinking agent include an amino resin, blocked polyisocyanate, polycarbodiimide compounds and the like. Among these crosslinking agents, the amino resin is preferable.

Examples of the above-mentioned acrylic resin include copolymers of acrylic monomers and other ethylenic unsaturated monomers. Examples of the acrylic monomers include methyl (meth)acrylate, ethyl (meth)acrylate, propyl (meth)acrylate, butyl (meth)acrylate, 2-ethylhexyl (meth)acrylate, lauryl (meth)acrylate, phenyl (meth)acrylate, benzyl (meth)acrylate, 2-hydroxyethyl (meth)acrylate, 2-hydroxypropyl (meth)acrylate, acrylamide, methacrylamide, N,N-dimethyl acrylamide, N,N-dimethyl methacrylamide, N,N-dibutyl acrylamide, N,N-dibutyl methacrylamide, a ring-opening adduct of caprolactone of 2-hydroxyethyl acrylate or 2-hydroxyethyl methacrylate, (meth)acrylate of polyhydric alcohol, and the like. Examples of the above-mentioned other ethylenic unsaturated monomers include styrene, α-methylstyrene, itaconic acid, maleic acid, vinyl acetate and the like.

The polyurethane resin is not limited as long as it is a water-based urethane resin commonly used. Particularly, the urethane dispersion is preferable. A common polyurethane resin is formed by reacting polyol with isocyanate and extending a chain length of the reaction product. Polyester, polyether and acryl, which have a hydroxyl group, are preferable as this polyol. The conversion of the polyurethane resin to a water-based polyurethane resin can be performed by a method for emulsifying using a surfactant, or a method in which a polyurethane resin having a carboxyl group is neutralized with amine or ammonium and subjected to forced emulsification, and a polyurethane dispersion subjected to forced emulsification is preferable.

Examples of the dispersion of the polyurethane resin include commercially available products such as TAKELAC XW-75, TAKELAC W-165, TAKELAC W-166, TAKELAC A-170, TAKELAC X-35 (all produced by Takeda Pharmaceutical Co., Ltd.), NeoRez R9649, NeoRez R966, NeoRez R972 (produced by Avecia Ltd.), DALTON VTW6465/36 (produced by Solutia Japan Ltd.), SUPERFLEX series 110, 150, 460S (all produced by DAI-ICHI KOGYO SEIYAKU Co., Ltd.).

The above-mentioned blocked polyisocyanate refers to polyfunctional isocyanate compounds blocked with a blocking agent such as alcohol, tertiary amine, lactam, and oxime. The above-mentioned polyfunctional isocyanate compounds is not particularly limited, and examples of the compounds include compounds described above.

The above-mentioned polycarbodiimide compound is a compound having at least two carbodiimide groups (—N═C═N—) in a molecule

Examples of the above-mentioned amino resin include di methylol melamine, trimethylol melamine, tetramethylol melamine, pentamethylol melamine, hexamethylol melamine and alkyl-etherized products (alkyl is methyl, ethyl, propyl, isopropyl, butyl, isobutyl and the like) thereof, urea-formaldehyde condensate, urea-melamine copolycondensation product and the like.

In the coating material (i), as for the ratio between the resin forming a matrix and the crosslinking agent, preferably, the ratio of the resin forming a matrix is 90 to 50% by mass and the ratio of the crosslinking agent is 10 to 50% by mass, and it is preferable that the ratio of the resin forming a matrix is 85 to 60% by mass and the corresponding ratio of the crosslinking agent is 15 to 40% by mass. When the ratio of the crosslinking agent is less than 10% by mass, crosslinking in the coating film may be insufficient. On the other hand, when the ratio of the crosslinking is more than 50% by mass, storage stability of the coating material composition is deteriorated and a curing rate increases, and therefore the coating film appearance may be deteriorated.

The water-based resin can be obtained by adjusting an acid value and neutralizing an acid group such as a carboxyl group with a basic substance. Examples of the basic substance include amine compounds, and among these amine compounds, diethanolamine, dimethylethanolamine, triethanolamine and the like are suitable. As a solvent, water is predominantly used, but an organic solvent can be used in combination with deionized water.

Examples of the bright pigment include flake pigments such as an aluminum flake pigment, an alumina flake pigment coated with metal oxide, a silica flake pigment coated with metal oxide, a graphite pigment, an interference mica pigment, a color mica pigment, a metal titanium flake pigment, a stainless flake pigment, a plate iron oxide pigment, a metal-plated glass flake pigment, a metal oxide-plated glass flake pigment, a hologram pigment, and a cholesteric liquid crystal polymer.

The bright pigment of the coating material (i) preferably has a weight concentration (pigment weight concentration: PWC) of 5 to 20%. When the above-mentioned PWC is less than 5%, a hiding property may be insufficient, and when the PWC is more than 20%, various performance of the coating film may be deteriorated. The PWC is more preferably 8 to 15%.

The coating material (i) may include a coloring pigment or an extender pigment as required in addition to the bright pigment. As the coloring pigment and the extender pigment, publicly known substances can be used.

The coating material (i) may appropriately contain a publicly known additive in addition to the above-mentioned water-based resin and bright pigment.

### [Step 3]

In the present invention, the step (3) is a step of applying a water-based bright coating material (ii) to the first base coating film to form a second base coating film.

As a constituent component of the coating material (ii), materials of content described in the coating material (i) can be used similarly. That is, the coating material (ii) includes a water-based resin, a bright pigment and water and is a coating material in which the water-based resin and the bright pigment are dissolved or dispersed in water as with the coating material (i). Further, these constituent components are similar to those exemplified in the description of the coating material (i).

Application of the above-mentioned coating material (ii) is not particularly limited, and it can be performed by applying and drying the coating material (i) in the same way as in the step (1) described above, and among others, it is preferable to perform spray coating. Drying in the step (3) is preferably performed at a temperature of 30 to 90° C. for 1 to 5 minutes after performing setting at room temperature for 1 to 3 minutes.

The dried film thickness of the second base coating film is preferably 5 to 15 μm. When the dried film thickness is less than 5 μm, the coating film is so thin that a continuous uniform film tends not to be obtained. When the dried film thickness is more than 15 μm, water resistance and the like tend to deteriorate.

The ratio of the dried film thickness of the first base coating film to that of the second base coating film is preferably set at 2/1 to 1/1. That is, it is preferable that the dried film thickness of the first base coating film is close to that of the second base coating film. When the ratio of the dried film thickness of the first base coating film to that of the second base coating film is less than 2/1, the orientation of the bright pigment may be deteriorated, and when it is more than 1/1, uneven brightness may be produced. This ratio is more preferably 1.5/1 to 1/1.

In the present invention, by preheating at a temperature of 30 to 90° C. for 1 to 5 minutes in a drying oven as required after forming the second base coating film, an un-cured multilayer coating film of three-layers including the primer coating film and the un-cured multilayer base coating film can be obtained.

The above-mentioned preheating is preferably performed at a temperature of 50 to 80° C. for 2 to 5 minutes.

The bright pigment of the coating material (ii) preferably has a PWC of 10 to 25%.

When the above-mentioned PWC is less than 10%, sufficient brightness sometimes cannot be obtained, and when the PWC is more than 25%, the orientation of the bright pigment may be deteriorated and the coating film appearance may be deteriorated. The PWC is more preferably 10 to 20%.

The PWC ratio of the bright pigment contained in the coating material (i) to that contained in the coating material (ii) is preferably set at 1/5 to 1/1.25. That is, it is preferable that the PWC of the bright pigment contained in the coating material (ii) is larger than that contained in the coating material (i).

When this PWC ratio of the bright pigment is less than ⅕, uneven brightness may be produced, and when it is more than 1/1.25, adequate orientation of the bright pigment may not be obtained. This ratio is more preferably 1/2.5 to 1/1.25.

In the present invention, it is preferable to obtain an un-cured base coating film by preheating at a temperature of 30 to 90° C. for 2 to 8 minutes in a drying oven as required after forming the second base coating film.

### [Step 4]

In the present invention, the step (4) is a step of applying a high-solid clear coating material to the second base coating film to form a clear coating film. By forming the clear coating film, the gloss of a coating film to be obtained can be improved and the protrusion of the bright pigment in the second base coating film can be prevented.

Application of the high-solid clear coating material can be performed in the same way as in the step (1) described above.

The dried film thickness of the clear coating film is preferably 10 to 50 μm, and when the dried film thickness does not fall within this range, a defect may occur in the coating film appearance or the workability of coating.

The high-solid clear coating material generally includes an acrylic resin.

The high-solid clear coating material preferably includes an acrylic resin having: a hydroxylalkyl group represented by any one of the following formulae (1) to (3) on the side chain; and polyisocyanate.

As a clear coating material, an environment-responsive two-component high-solid clear coating material, in which a molecular weight of a resin is relatively small and the emission level of a solvent is low, is previously known. However, it was found that when such an environment-responsive coating material is used as a clear coating material in the present invention, the resin in this clear coating material penetrates the second base coating film during setting or preheating after applying the clear coating material to move the bright pigment in the second base coating film and disturb the orientation of the bright pigment, and therefore the bright appearance may be deteriorated.

The present inventors have made intensive investigations, and consequently have found that by employing a high-solid clear coating material (hereinafter, this high-solid clear coating material is referred to as a “clear coating material α”) containing such an acrylic resin and polyisocyanate as a clear coating material, a clear coating film can be formed without disturbing the orientation of the bright pigment of the second base coating film and that the process step can be further shortened since the volatilization of a solvent is small.

In the above-mentioned clear coating material α, a nonvolatile content of a diluted coating material, that is, the nonvolatile content upon applying, is generally 52% by mass or more, and preferably 55% by mass or more.

In the present specification, the nonvolatile content upon applying described above refers to a nonvolatile content measured when viscosity, which is measured at 20° C. using a No. 4 Ford cup according to JIS K 5600-2-2-3 immediately after mixing/stirring the above-mentioned resin and solvent, is about 20 seconds. The nonvolatile content upon applying is an amount of a residue in heating a mixture of a resin and a solvent to 105° C. for 3 hours according to JIS K 5601-1-2.

The nonvolatile content can be adjusted so as to fall within the present range, for example, by maintaining a weight average molecular weight within a range described later.

The clear coating material α is preferably a two-component type.

An acrylic resin in the clear coating material a can be prepared, for example, by polymerizing a radically polymerizable monomer exemplified on the above-mentioned water-based bright coating material (i), but the acrylic resin preferably has a hydroxylalkyl group described in any one of the following formulae (1) to (3) as a side chain.

Since such a hydroxylalkyl group has a relatively few hydrogen bonds with a carbonyl group in a molecule and has a moderate length as a side chain, the orientation of the bright pigment of the second base coating film is not disturbed. Further, when the acrylic resin has such a hydroxylalkyl group as a side chain, a crosslinking reaction with isocyanate occurs relatively quickly even though the molecular weight of the acrylic resin is small and therefore the penetration of the acrylic resin into the second base coating film is inhibited. Accordingly, when a clear coating material containing the acrylic resin having such the hydroxylalkyl group is used as the clear coating material α, a coating film having an excellent bright appearance can be attained.

The acrylic resin in the clear coating material a preferably has a weight average molecular weight of 4500 to 8000 in the case where the acrylic resin has the hydroxylalkyl group.

In the present specification, the weight average molecular weight is determined by a GPC method.

Though the acrylic resin is an acrylic resin having a hydroxylalkyl group different from the above-mentioned hydroxylalkyl group, for example, an acrylic resin formed by polymerization of 2-hydroxylethyl methacrylate, if the nonvolatile content upon applying is low, a resin in the clear coating material does not disturb the orientation of the bright pigment of the second base coating film. Examples of such the acrylic resin include acrylic resins having a high molecular weight of more than 8000 in a weight average molecular weight.

The acrylic resin in the clear coating material α is preferably formed by polymerizing a monomer composition containing at least one of (meth)acrylic monomers having a hydroxyl group represented by any one of the following formulae (1) to (3):

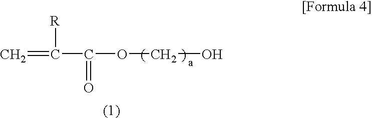

wherein “R” represents H (hydrogen) or CH₃ and a represents an integer of 3 or 4,

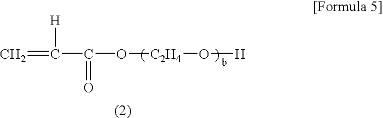

wherein “b” is 2 to 5 in the mean, and

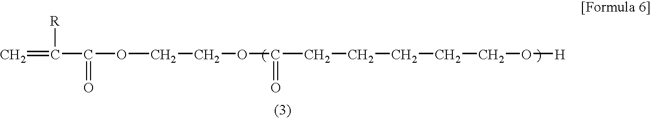

wherein “R” is the same as defined above.

In the clear coating material α, the acrylic resin preferably has a hydroxyl value of 90 to 180 (KOH mg/g). When the hydroxyl value is more than 180 (KOH mg/g), it is not desirable since a crosslinking reaction may not occur and this may cause a remaining hydroxyl group to increase and water resistance to deteriorate. Further, when the hydroxyl value is less than 90 (KOH mg/g), a crosslinking density is low and chemical resistance or solvent resistance may be deteriorated because of the reduction in film cohesion.

In the present specification, the above-mentioned hydroxyl value is measured by an acetic anhydride-pyridine method.

In the clear coating material α, polyisocyanate is not particularly limited as long as it is a compound having two or more isocyanate groups. Examples of the polyisocyanate include: aromatic polyisocyanates such as trilene diisocyanate, 4,4′-diphenylmethane diisocyanate, xylylene diisocyanate, and methxylylene diisocyanate; aliphatic polyisocyanates such as hexamethylene diisocyanate; alicyclic polyisocyanates such as isophorone diisocyanate; the above-mentioned monomers; polymers of the above-mentioned biuret type, nurate type or adduct type; and the like.

The polyisocyanate is more preferably a multimer from the viewpoint of a curing property, and it is more preferably selected based on the performance of a coating film to be obtained. It is preferable not to use an aromatic polyisocyanate from the viewpoint of weather resistance, and aliphatic polyisocyanates and alicyclic polyisocyanates are preferable.

Examples of commercially available products of the polyisocyanate include SUMIDUR N3200-90CX, SUMIDUR N3500 (all produced by Sumitomo Bayer Urethane Co., Ltd.), DURANATE 24A-90PX, DURANATE THA-100 (all produced by NIPPON POLYURETHANE INDUSTRY CO., LTD.), and Takenate D165N-90CX, Takenate D170N (all produced by Takeda Pharmaceutical Co., Ltd.), and the like. In the above-mentioned two-component curing high-solid coating material, the ratio (NCO/OH) of equivalent weight between the above-mentioned NCO group and the hydroxyl group of the acrylic resin is preferably 0.8 to 2.0. When the ratio is less than 0.8, it is not desirable since coating film performance such as scratch resistance and solvent resistance is deteriorated. Further, when the ratio is more than 2.0, it is not desirable since a coating film to be obtained is hard and cracks may be produced with time.

The clear coating material a preferably has an efflux viscosity of 15 to 25 seconds measured according to JIS K 5600-2-2-3, and more preferably 15 to 20 seconds. When the viscosity is within such a range, an excellent appearance can be readily formed since the atomization of a coating material during applying the coating material is favorable.

In the present specification, the viscosity is measured using a No. 4 Ford cup according to JIS K 5600-2-2-3 after an acrylic resin, polyisocyanate and a dilution thinner were mixed under stirring and immediately a temperature of a coating material is adjusted to 20° C.

In the present invention, the high-solid clear coating material can be mixed with an additive such as a coloring pigment, an extender pigment, a modifier, an ultraviolet absorber, a leveling agent, a dispersant and an antifoaming agent within a range of not impairing its transparency as required.

### [Step 5]

In the present invention, the step (5) is a step of heat-curing the water-based primer coating film, the first base coating film, the second base coating film, and the clear coating film simultaneously to form a cured coating film. By undergoing such heat-curing, a bright coating film composed of a multilayer can be provided on the surface of the substrate. The present invention is more simple and lower in energy cost than a conventional process step of a wet-on-wet system in that not only the first base coating film, the second base coating film and the clear coat simultaneously but also the primer coating film is heat-cured simultaneously.

Heating conditions in the above-mentioned heat-curing are not particularly limited as long as the conditions of temperature and time under which the substrate is not thermally deformed and favorable coating film performance can be achieved are selected.

The above-mentioned heating temperature is generally 50 to 100° C., and preferably 70 to 90° C. When the baking temperature is lower than 50° C., it is not preferable since much heating time may be required. When a heating temperature is higher than 100° C., there may be cases where poor conditions such as popping and cratering are produced and a coating film having a favorable appearance cannot be obtained.

The above-mentioned heating is generally performed for 10 to 60 minutes, preferably 15 to 50 minutes, and more preferably 20 to 40 minutes. When the heating time is shorted than 10 minutes, there may be cases where a coating film having favorable performance such as weather resistance, water resistance, and solvent resistance is not attained. On the other hand, when the heating time is longer than 60 minutes, a coating film is cured excessively and the adhesion property may be deteriorated, a total time of a coating step may be long and energy cost may be large.

Examples of heating equipment used for the curing by heating include a drying oven and the like to utilize heating sources such as hot air, electricity, gas, and infrared. Further, use of a drying oven, in which these heating sources are used in combination of two or more kinds, is preferable since a drying time is shortened.

### EFFECTS OF THE INVENTION

Since the method for forming the multilayer coating film of the present invention has the above-mentioned constitution, it can shorten the process step and can form a bright coating film having excellent brightness and an excellent appearance.

### BEST MODE FOR CARRYING OUT THE INVENTION

Hereinafter, the present invention will be described in more detail by way of Examples, but the present invention is not limited to these Examples. In addition, “part(s)” and “%” refer to “part(s) by mass” and “% by mass” in Examples, unless otherwise specified.

### Production Example 1

### Production of polypropylene AP-1

A 1000-mL round bottom flask was charged with 110 mL of deionized water, 22.2 g of magnesium sulfate heptahydrate and 18.2 g of sulfuric acid, and the resulting mixture was dissolved under stirring to form a solution. Commercially available granulated montmorillonite 16.7 g was dispersed in the resulting solution, and the resulting dispersion was heated to 100° C. and stirred for two hours. Thereafter, the dispersion was cooled to room temperature to obtain slurry. The obtained slurry was filtrated to recover wet cake. The recovered wet cake was brought into slurry again in the 1000-mL round bottom flask using 500 mL of deionized water and the obtained slurry was filtrated. This operational procedure was repeated twice. Ultimately obtained cake was dried at 110° C. over a night in an atmosphere of nitrogen to obtain 13.3 g of chemically treated montmorillonite.

To 4.4 g of the obtained chemically treated montmorillonite, 20 mL of a toluene solution (0.4 mmol/ml) of triethylaluminum was added, and the resulting mixture was stirred at room temperature for 1 hour. To the resulting suspension, 80 mL of toluene was added, and after stirring the mixture, a supernatant fluid was removed. This operational procedure was repeated twice, and then toluene was added to obtain clay slurry (slurry concentration: 99 mg clay/ml).

Triisobutylaluminum 0.2 mmol was put into another flask, and then, 19 mL of the obtained clay slurry and 131 mg (57 μmol) of a diluted toluene solution of dichloro[dimethylsilylene(cyclopentadienyl)-(2,4-dimethyl-4 H-5,6,7,8-tetrahydro-1-azulenyl)]hafnium were added, and the resulting mixture was stirred at room temperature for 10 minutes to obtain a catalyst slurry.

Next, into an autoclave of induced mixing type with an internal volume of 24 L, 11 L of toluene, 3.5 mmol of triisobutylaluminum and 2.64 L of liquid propylene were introduced. All of the above-mentioned catalyst slurry was introduced at room temperature, and the content was heated to 67° C. and stirred at this temperature for 2 hours while maintaining the total pressure at 0.65 MPa and the hydrogen concentration at 400 ppm during polymerization. After the completion of stirring, unreacted propylene was purged from the autoclave to terminate the polymerization. The autoclave was opened to recover all of a toluene solution of polymer. The solvent and a clay residue were removed from the toluene solution to obtain 11 kg of a 10.9% by mass polypropylene toluene solution (1.20 kg of polypropylene). The obtained polypropylene AP-1 had a weight average molecular weight Mw of 300000 (polystyrene equivalent value) and a crystallinity of a PP segment of 45%.

### Production Example 2

### Production of polypropylenes AP-2 to AP-7

Polypropylenes AP-2 to AP-7 were produced by following the same procedure as in Production Example 1 except for changing the polymerization conditions to those shown in Table 1.

### Production Example 3

### Production of Maleic Anhydride Modified Polypropylene APM-1

Into a glass flask equipped with a reflux condenser, a thermometer, and a stirrer, 400 g of the polypropylene AP-1 obtained in Production Example 1 and 600 g of toluene were put, and the gas phase in the flask was replaced with a nitrogen gas and the content of the flask was heated to 110° C. After heating, 100 g of maleic anhydride was added and 30 g of t-butyl peroxy isopropyl monocarbonate (produced by NOF CORPORATION, PERBUTYL I (PBI)) was added, and the resulting mixture was stirred at this temperature for 7 hours to perform a reaction. After the completion of the reaction, a system was cooled to near room temperature, and acetone was added to a reactant to precipitate a polymer, and the precipitated polymer was separated by filtration. Further, precipitation and separation by filtration were repeated using acetone, and an ultimately obtained polymer was washed with acetone. White powdery maleic anhydride modified polymer APM-1 was obtained by drying, under a reduced pressure, a polymer obtained by washing. The infrared absorption spectrum of this modified polymer was measured, and consequently the content (degree of grafting) of a maleic anhydride group was 3.7% by mass (0.37 mmol/g). Further, the weight average molecular weight was 140000.

### Production Example 4

### Production of Maleic Anhydride Modified Polypropylenes APM-2 to APM-8

Maleic anhydride modified polypropylenes APM-2 to APM-8 were produced by following the same procedure as in Production Example 3 except for changing polypropylene to be used and the composition to those shown in Table 2.

### Production Example 5

### Production of Water-Based Maleic Anhydride Modified Polypropylene APMW-1

Into a glass flask equipped with a reflux condenser, a thermometer, and a stirrer, 100 g of the maleic anhydride modified polypropylene APM-1 (weight average molecular weight: 140000, degree of grafting of maleic anhydride: 3.7%) obtained in Production Example 3 and 150 g of tetrahydrofuran were put, and the resulting mixture was heated to 65° C. and dissolved. Next, 5.8 g (2 chemical equivalent) of dimethylethanolamine was added, and 400 g of deionized water of 60° C. was added dropwise while keeping the temperature at 65° C. to perform a phase inversion, and then 0.1 g of hydroquinone was added as an antioxidant, and the temperature of the resulting mixture was gradually raised to distill off tetrahydrofuran and obtain a milky white dispersion. A solid content of this dispersion was adjusted to 20% by mass by adding deionized water. The particle diameter of this water dispersion was 0.1 μm or less.

### Production Example 6

### Production of Water-Based Maleic Anhydride Modified Polypropylenes APMW-2 to APMW-7

Water-borne maleic anhydride modified polypropylenes APMW-2 to APMW-7 were produced by following the same procedure as in Production Example 5 except for changing the amount to be blended to those shown in Table 3.

### Production Example 7

### Production of Water-Based Maleic Anhydride Modified Polypropylene APMW-8

To a reaction apparatus equipped with a mixing blade, a thermometer, added were a dropping equipment, a temperature control unit and a condenser, 100 g of the maleic anhydride modified polypropylene APM-1 obtained in Production Example 3 and 250 g of toluene, and the resulting mixture was heated to 100° C. to be dissolved, and cooled to 70° C. Thereafter, 15 g of a nonionic surfactant EMULGEN 220 (produced by KAO Corporation, HLB: 14.2, solid content: 100%) and 15 g of a nonionic surfactant EMULGEN 147 (produced by KAO Corporation, HLB: 16.3, solid content: 100%) were added and dissolved, and cooled to 50° C. Deionized water 520 g was gradually added while keeping the temperature at 50° C. to emulsify the content through a phase inversion. Then, the content was cooled to room temperature, and 2-amino-2-methyl-1-propanol was added to adjust a pH to 8. Then, toluene was removed from the content under a reduced pressure and a small amount of deionized water was added for adjustment to obtain a water dispersion of polypropylene having a solid content of 20% (solid content of AMP: 15.4%, solid content of emulsifier: 4.6%). The average particle diameter of the water dispersion of polypropylene was 0.38 μm.

### Production Example 8

### Production of Polyalkylene Glycol Modified Polypropylene APMW-9

Into a glass flask equipped with a reflux condenser, a thermometer, and a stirrer, 100 g of the maleic anhydride modified propylene polymer APM-8 (the content of a maleic anhydride group: 12 mmol) obtained in Production Example 4 and 250 g of toluene were put, and the resulting mixture was heated to 110° C. and completely dissolved. Next, a solution formed by dissolving 15.0 g (15.0 mmol, this amount represents 15 parts by weight with respect to 100 parts by weight of the propylene polymer) of a poly(oxyethylene-oxypropylene) block copolymer (molecular weight: 1000) in 22.5 g of toluene was added, and the resulting mixture was reacted at 110° C. for 3 hours.

After cooling a reactant, toluene was distilled off from the reactant under a reduced pressure to obtain 113 g of a yellow polymer. Infrared absorption spectrum analysis of the obtained product was performed, and consequently it was verified that a peak near 1784 cm⁻¹ representing maleic anhydride disappeared and a maleic anhydride modified propylene polymer was bound to polyether. A graft copolymer in which polyether is bonded to the maleic anhydride modified propylene polymer by grafting is formed.

Tetrahydrofuran (THF) 160 g was added to 40 g of the obtained modified polymer, and the resulting mixture was completely dissolved at 65° C. Deionized water 200 g was added dropwise to the resulting solution at this temperature over 1 hour to obtain a semitransparent light yellow solution. This solution was cooled to 50° C., and by gradually lowering a pressure level from 0.03 MPa to 0.0045 MPa, THF and deionized water were distilled off from the solution under a reduced pressure until the solid content of a resin reaches 21% by weight to obtain a semitransparent light yellow dispersion of a water-based resin.

According to the measurement of the particle diameter of the dispersed particle, a 50% cumulative particle diameter was 0.04 μm and a 90% cumulative particle diameter was 0.09 μm. Table 3 shows physical properties of the obtained dispersion of a water-based resin. The particle diameter was small and storage stability was favorable.

In addition, the poly(oxyethylene-oxypropylene) block copolymer used in the present Example is a hydrophilic polymer because when it is dissolved at a concentration of 10% by weight in deionized water of 25° C., the content of insoluble matter is 1% by weight or less.

### Production Example 9(1)

### Production of Water-Based Primer Coating Material

To an appropriate container equipped with a stirrer, 12.03 parts of SUPERFLEX 150 (produced by DAI-ICHI KOGYO SEIYAKU Co., Ltd., water-based polyurethane resin), 7.47 parts of EPIREZ 5003W55 (produced by Japan Epoxy Resins Co., Ltd., water-based epoxy resin), 25.27 parts of APMW-1 obtained above, 6.02 parts of an internally crosslinked acrylic particle emulsion, 27.77 parts of pigment paste, 19.28 parts of deionized water, 0.72 part of an antifoaming agent DYNOL 604 (produced by Air Products and Chemicals, Inc.), 1.44 parts of a thickener ASE-60 (Rohm and Haas Company), and 0.01 part of dimethylethanolamine (produced by KISHIDA CHEMICAL Co., Ltd.) were added dropwise one by one, and the resulting mixture was stirred for 1 hour to obtain an aimed coating material.

### Production Examples 9(2) to 9(25)

Coating materials were produced by following the same procedure as in Production Example 9(1) except for blending raw materials in the composition shown in Tables 4-1, 4-2, 5-1, and 5-2.

In addition, the pigment dispersed pastes and the internally crosslinked acrylic particle emulsions used in the above Production Examples were produced by the following method.

### (Production of Pigment Dispersed Paste)

To an appropriate container equipped with a stirrer, 11.75 parts of a water-based acrylic resin (acid number of solid matter: 50 mg KOH/g, weight average molecular weight: 30000, nonvolatile content: 30% by mass), 2.07 parts of Surfynol T324 (pigment dispersing agent produced by Air Products and Chemicals, Inc.), 1.61 parts of Surfynol 440 (antifoaming agent produced by Air Products and Chemicals, Inc.), 38.5 parts of deionized water, 2.54 parts of carbon black ECP 600JD (conductive carbon produced by LION CORPORATION), 37.64 parts of Ti-Pure R960 (titanium dioxide pigment produced by DuPont Company), and 5.89 parts of NIPSEAL 50B (silica produced by NIPPON SILICA CORPORATION) were added one by one under stirring, and after the resulting mixture was stirred for 1 hour, the mixture was dispersed until a particle diameter measured by a grind gauge reaches 20 μm or less with a 1.4-L dynomill (produced by Willy A. Bachoten AG Moschinenfabrik) for laboratory to obtain pigment dispersed paste.

This pigment dispersed paste had a nonvolatile content of 52% by mass and a viscosity of 60 KU (20° C.).

### (Production of Internally Crosslinked Acrylic Particle Emulsions AC-1 to AC-6)

To a solution formed by adding 5.0 parts of PELEX-SSH (produced by KAO CORPORATION, sodium alkyl diphenyl ether disulfonate) to 220 parts of deionized water, 100 parts of blended ethylenic unsaturated monomers having the composition shown in Table 6 was gradually added to prepare an emulsified substance.

Next, into a glass flask equipped with a condenser, a thermometer, and a stirrer, 100 parts of deionized water was put, and heated to 80° C. Then, an initiator aqueous solution containing the above-mentioned emulsified substance, 15.0 parts of deionized water and 0.03 part of ammonium persulfate was added dropwise over 3 hours to obtain the aimed crosslinked acrylic particle emulsion. Further, the glass transition temperatures (Tg) of acryl resin of the respective emulsions excluding crosslinkable monomers were as shown in Table 6.

### (Production of Internally Crosslinked Acrylic Particle Emulsion AC-7)

To a solution formed by adding 15.0 parts of PELEX-SSH (produced by KAO CORPORATION, sodium alkyl diphenyl ether disulfonate) to 220 parts of deionized water, 100 parts of blended ethylenic unsaturated monomers having the composition shown in Table 6 was gradually added to prepare an emulsified substance.

Next, into a glass flask equipped with a condenser, a thermometer, and a stirrer, 100 parts of deionized water was put, and heated to 80° C. Then, an initiator aqueous solution consisting of the above-mentioned emulsified substance, 15.0 parts of deionized water and 0.03 part of ammonium persulfate was added dropwise over 3 hours to obtain the aimed crosslinked acrylic particle emulsion. Further, the glass transition temperatures (Tg) of acryl resin excluding crosslinkable monomers was 100° C.

### Production Example 10

### Production of Water-Based Bright Coating Material (i)

### (Preparation of Water-Based Acrylic Resin A)

Into a reaction vessel equipped with a stirrer, a thermometer, a reflux tube, a dropping funnel, a nitrogen inlet tube and a heating unit with a thermostat, 27 parts of 2-ethylhexyl glycol (EHG) ether was fed, and an internal liquid temperature was gradually raised to 110° C. under stirring. While passing a nitrogen gas through the reaction vessel, a monomer mixture solution containing 5 parts of methacrylic acid (MAA), 8 parts of 2-hydroxyethyl acrylate (HEA), 30 parts of methyl methacrylate (MMA) and 57 parts of ethyl acrylate (EA) and a solution containing 1.5 parts of t-butylperoxydietylhexanoate (TBPODEH) of a radical polymerization catalyst and 10 parts of EHG are put in two separate dropping funnels under a nitrogen stream, respectively, and both solutions were added dropwise over 3 hours. An internal liquid temperature was maintained at near 110° C. during adding dropwise. After the completion of dropping, a polymerization catalyst solution containing 0.5 parts of TBPODEH and 5 parts of EHG was added dropwise over 1 hour while further maintaining the liquid temperature at 110° C.

Thereafter, the reaction solution was further aged for 1 hour while maintaining the liquid temperature at 110° C. and then the liquid temperature was lowered to 70° C., and to this reaction solution, 2 parts of EHG and 30 parts of methoxypropanol (MP) were added to dilute the reaction solution. Subsequently, a solvent was removed from the reaction solution under a reduced pressure while maintaining the liquid temperature at 70° C. to distill off mainly MP and this desolvation was completed over about 2 hours at the time when a fraction of distilled off MP reaches 25 parts.

The nonvolatile content of a solvent resin in the reaction vessel was 67.5%. This solvent resin had an acid value of 30 and a hydroxyl value of 39. The molecular weight of the solvent resin was measured on the styrene equivalent basis by a GPC (gel permeation chromatography) method, and consequently the weight average molecular weight was 40000. Next, after the internal temperature was adjusted to 70° C. and 5 parts of dimethylethanolamine was added to the resin in the reaction vessel, 370 parts of deionized water was gradually added to the resulting mixture in the reaction vessel while stirring the resulting mixture and forced stirring was performed to obtain a water-based acrylic resin A. The nonvolatile content of this water-based acrylic resin A was 19%.

### (Preparation of Water-Based Acrylic Resin B)

A water-based acrylic resin B was obtained by following the same procedure and the same order as in the water-based acrylic resin A, except that a mixture of 8 parts of MAA, 15 parts of HEA, 15 parts of MMA, 52 parts of EA and 10 parts of styrene (total 100 parts) was used as a monomer mixture solution and the mixed solution added dropwise concurrently with the monomer mixture solution was composed of 10 parts of EHG and 3 parts of TBPODEH.

The nonvolatile content of a solvent resin after removing the solvent was 68%. This solvent resin had an acid value of 53 and a hydroxyl value of 67. The molecular weight of the solvent resin was measured on the styrene equivalent basis by a GPC (gel permeation chromatography) method, and consequently the weight average molecular weight was 27000.

When the water-based acrylic resin B was prepared, the conversion of a resin to a water-based resin was performed by adjusting the internal temperature to 70° C., adding 9 parts of dimethylethanolamine to the resin in the reaction vessel, then gradually adding 182 parts of deionized water to the resulting mixture in the reaction vessel while stirring the resulting mixture and performing forced stirring. The nonvolatile content of this water-based acrylic resin B was 30%.

### (Preparation of Water-Based Bright Coating Material (i))

Into a container equipped with a stirrer, a water-based acrylic resin A (70 parts), a water-based acrylic resin B (200 parts), a melamine resin (XM 2677, produced by Cytec Japan Ltd.; 38 parts), and a 10% amine aqueous solution of DMEA (4 parts) were fed under stirring. Into this container, a mixture formed by previously mixing EHG (10 parts), aluminum paste 65-388 (produced by TOYO ALUMINIUM K.K., 27 parts) and an additive BYK-192 (produced by BYK Corporation, 0.7 part) was fed while further stirring the content of the container. Thereafter, to the resulting mixture, a urethane dispersion (NeoRez R972, produced by Avecia Ltd.; 66 parts), JP-508 (produced by Johoku Chemical Co., Ltd.; 0.4 part) and a thickener (ADEKANOL UH-752, produced by ADEKA Corp.; 2.5 parts) were added and 350 parts of deionized water was added to obtain a water-based bright coating material (i).

The obtained water-based bright coating material (i) had a nonvolatile content of 19% and an amount of the bright pigment was 12.9%.

### Production Example 11

### Production of Water-Based Bright Coating Material (ii)

Into a container equipped with a stirrer, a water-based acrylic resin A (70 parts), a water-based acrylic resin B (200 parts), a melamine resin (XM 2677, produced by Cytec Japan Ltd.; 38 parts), and a 10% amine aqueous solution of DMEA (10 parts) were fed under stirring. Into this container, a mixture formed by previously mixing EHG (10 parts), aluminum paste 65-388 (produced by TOYO ALUMINIUM K.K., 42 parts) and an additive BYK-192 (produced by BYK Corporation, 0.7 part) was fed while further stirring the content of the container. Thereafter, to the resulting mixture, a urethane dispersion (NeoRez R972, produced by Avecia Ltd.; 66 parts), JP-508 (produced by Johoku Chemical Co., Ltd.; 0.4 part) and a thickener (ADEKANOL UH-752, produced by ADEKA Corp.; 4 parts) were added and 600 parts of deionized water was added to obtain a water-based bright coating material (ii).

The obtained water-based bright coating material (ii) had a nonvolatile content of 15% and an amount of the bright pigment was 18.7%.

### Production Example 12 (1)

### Production of Clear Coating Material 1

### (Production of Acrylic Resin a)

Into a reaction vessel equipped with a stirrer, a thermometer, a reflux tube, a dropping funnel, a nitrogen inlet tube and a heating unit with a thermostat, 42 parts by weight of butyl acetate was fed, and an internal temperature was gradually raised to 125° C. Then, under a nitrogen stream, a monomer mixture solution containing 5.3 parts of ethylhexyl acrylate (EHA), 45.1 parts of t-butylmethacrylate (TBMA), 10 parts of styrene (ST), 1.1 parts of methacrylic acid (MAA), 38.5 parts of hydroxybutyl acrylate (HBA) and 12 parts of t-butyl peroxydiethylhexanoate (TBPODEH) of a polymerization initiator was added dropwise over 3 hours with a dropping funnel while internally stirring. An internal temperature was maintained at about 128° C. in a state of weak reflux. Subsequently, a solution formed by dissolving 0.5 part of a polymerization catalyst TBPODEH in 5 parts of butyl acetate was added dropwise over 1 hour with a dropping funnel under internal stirring at an internal temperature of 128° C. The resulting mixture was further maintained at this temperature over 2 hours to age the mixture to obtain an acrylic resin a.

This acrylic resin had a nonvolatile content of 70% and a weight average molecular weight of 6000 on the styrene equivalent basis, which was measured by a GPC (gel permeation chromatography) method. Further, its hydroxyl value (hereinafter, referred to as an OHV) based on an acetic anhydride-pyridine method was 150. As a nonvolatile content, the nonvolatile content in the case of heating the acrylic resin to 105° C. for 3 hours according to JIS K 5601-1-2 was determined.

### (Production of Acrylic Resins b to i)

Acrylic resins b to i were synthesized by following the same procedure as in the above-mentioned acrylic resin a except for changing the composition of each monomer, the solvent, and the amount of the catalyst to those shown in Table 7.

In addition, the acrylic resin f has a hydroxylalkyl group different from the above-mentioned hydroxylalkyl group, the acrylic resin g and the acrylic resin i have large average molecular weights, and in the acrylic resin h, the size of a functional group having a hydroxyl group is small.

### (Preparation of Clear Coating Material)

Into a stainless steel vessel equipped with a mixing blade, the acrylic resin a (100.0 parts) and a mixed solvent (15.0 parts, hereinafter, this mixed solvent is referred to as a “mixed solvent I”) containing Solfit AC (solvent produced by Kuraray Co., Ltd.) and butyl acetate in a mass ratio of 3:2 were fed in turn and the resulting mixture was stirred to be mixed uniformly.

Subsequently, into this mixed solvent I (10 parts), a solution formed by dissolving TINUVIN 292 (hindered amine produced by Chiba Specialty Chemicals; 0.7 part) and TINUVIN 384-2 (ultraviolet absorber produced by Chiba Specialty Chemicals; 1.4 parts) was fed under stirring. Subsequently, into the resulting mixture, 0.7 part of BYK-310 (produced by BYK Corporation, surface control agent), 2.8 parts of BYKETOL SPECIAL (produced by BYK Corporation, surface control agent), and 0.1 part of dibutyl tin dilaurate (curing catalyst) were fed in turn and the resulting mixture was stirred and mixed uniformly. Then, into this uniform mixture, 47.6 parts of a curing agent R-271 (produced by BYK Corporation, polyisocyanate curing agent; nonvolatile content: 75%, NCO: 16.5%) was fed to produce a raw clear coating material.

Subsequently, the raw clear coating material was diluted with the mixed solvent I (13.0 parts) to produce a high-solid clear coating material 1. The viscosity at this time measured at 20° C. using a No. 4 Ford cup (produced by Ueshima Seisakusho Co., Ltd.) according to JIS K 5600-2-2-3 was 20 seconds, and the nonvolatile content was 57%.

### Production Examples 12(2) to 12(9)

Clear coating materials 2 to 8 of composition shown in Table 8 were produced by the same method as in the clear coating material 1. On these coating material, the viscosity was measured at 20° C. using a No. 4 Ford cup (produced by Ueshima Seisakusho Co., Ltd.) according to JIS K 5600-2-2-3. Further, the nonvolatile content was measured according to JIS K 5601-1-2. Table 8 shows the results of measurement of the nonvolatile content. In Table 10, the case where the nonvolatile content of the clear coating material is 52% or more is rated as favorable (symbol O) and the case where the nonvolatile content is less than 52% is rated as poor (symbol x).

### Examples 1 to 17 and Comparative Examples 1 to 14

The obtained coating material was applied by spray (dried film thickness: 10 μm) to a propylene material (size: 70 mm×260 mm×3 mm) cleaned with a mild detergent and dried at 80° C. for 3 minutes. Next, the water-based bright coating material (i) (“coating material (i)” in Table) was applied by spray (dried film thickness: 7 μm) to the dried coating material and set at room temperature for 2 minutes, and then a water-based bright coating material (ii) (“coating material (ii)” in Table) was applied by spray (dried film thickness: 7 μm), set at room temperature for 2 minutes, and further preheated at 80° C. for 5 minutes. Next, the clear coating material was applied by spray (dried film thickness: 30 μm), set at room temperature for 10 minutes, and then dried at 80° C. for 30 minutes to obtain a test piece.

On the obtained test piece, a cross-cut peeling test was performed and a coating appearance and brightness were evaluated according to the following methods. Tables 9-1, 9-2, 10-1, and 10-2 show the results of the test and evaluations.

### (Cross Cut Peel Test)

A cross-cut cellotape (registered trademark) peeling test was conducted according to JIS K 5600-5-6. 100 cross cuts of 2 mm square were prepared and a peeling test with a cellotape was performed and the number of cross cuts which had not been peeled off was counted.

The criteria of evaluations are as follows.

∘: 0/100 (no peeling)
x: 1/100 to 100/100 (peeling present)

### (Coating Appearance)

The test pieces (plates) were visually observed almost squarely (highlight part) and from an angle of about 15 degrees (shade part), and a glittering feel to show quality of a metallic appearance and a coating film appearance were visually evaluated. The appearance which does not exhibit a glittering feel is rated as favorable.

The criteria of evaluations are as follows.

∘: There is no glittering feel and a coating film is finished with a metallic appearance.
x: There are glittering feels in both a highlight part and a shade part, or there is uneven brightness or reduction in orientation.
(Brightness (IV value))

The brightness of the test plates were measured using an IV meter (“ALCOPE LMR-200” produced by Kansai Paint Co., Ltd.)

The criteria of evaluations are as follows.

∘: The IV value is 450 or more (brightness is favorable)
x: The IV value is 450 or less (brightness is poor)

TABLE 1

| | | | Mw on the polystyrene | | |
|---|---|---|---|---|---|
| Product name | temp/(° C.) | Pressure (MPa) | equivalent basis | Crystallinity (%) | PP (polypropylene) (wt %) |
| Production Example AP-1 | 67 | 0.65 | 300 thousand | 45 | 10.9 |
| Production Example AP-2 | 60 | 0.65 | 330 thousand | 51 | 7.9 |
| Production Example AP-3 | 50 | 0.50 | 300 thousand | 40 | 18.0 |
| Production Example AP-4 | 69 | 0.65 | 80 thousand | 41 | 12.5 |
| Production Example AP-5 | 90 | 0.75 | 150 thousand | 33 | 9.4 |
| Production Example AP-6 | 75 | 0.70 | 80 thousand | 36 | 7.3 |
| Production Example AP-7 | 60 | 0.65 | 240 thousand | 51 | 7.9 |
| Production Example AP-8 | 75 | 0.70 | 40 thousand | 36 | 7.3 |

TABLE 2

| | Name of | Amount to be blended | | | | Degree | Mw on the | |
|---|---|---|---|---|---|---|---|---|
| | substance | PP | Toluene | Maleic | | of grafting | polystyrene | Melting |
| Product name | used | AP-1 to 6 (g) | (g) | anhydride (g) | PBI (g) | (%) | equivalent basis | point (° C.) |
| Production Example APM-1 | AP-1 | 400 | 600 | 100 | 30 | 3.7 | 140 thousand | 75 |
| Production Example APM-2 | AP-2 | 350 | 650 | 90 | 30 | 3.8 | 120 thousand | 80 |
| Production Example APM-3 | AP-3 | 400 | 600 | 100 | 30 | 3.6 | 180 thousand | 60 |
| Production Example APM-4 | AP-4 | 600 | 400 | 100 | 35 | 3.8 | 60 thousand | 70 |
| Production Example APM-5 | AP-5 | 600 | 400 | 120 | 40 | 4.0 | 110 thousand | *1 |
| Production Example APM-6 | AP-6 | 400 | 600 | 30 | 10 | 4.0 | 30 thousand | 60 |
| Production Example APM-7 | AP-3 | 400 | 600 | 80 | 30 | 2.2 | 250 thousand | 60 |
| Production Example APM-8 | AP-7 | 40 | 300 | 10 | 5 | 1.1 | 56 thousand | *1 |
| | AP-8 | 160 | | | | | | |

*1 not having a melting point because of amorphous

TABLE 3

| | | Amount to be mixed | | | | | | | |
|---|---|---|---|---|---|---|---|---|---|
| | Number | Amount | Tetrahy- | | | | | | Particle |
| | of APM | of APM | drofuran | Dimethylethanolamine | EMULGEN | EMULGEN | Toluene | Deionized | diameter |
| Product name | used | (g) | (g) | (g) | 220 (g) | 147 (g) | (g) | water (g) | (μm) |
| Production Example APMW-1 | APM-1 | 100 | 150 | 5.8 | 0 | 0 | 0 | 400 | 0.1> |
| Production Example APMW-2 | APM-2 | 100 | 150 | 6.0 | 0 | 0 | 0 | 400 | 0.1> |
| Production Example APMW-3 | APM-3 | 100 | 200 | 5.7 | 0 | 0 | 0 | 400 | 0.1> |
| Production Example APMW-4 | APM-4 | 100 | 100 | 6.0 | 0 | 0 | 0 | 400 | 0.1> |
| Production Example APMW-5 | APM-5 | 100 | 150 | 6.3 | 0 | 0 | 0 | 400 | 0.1> |
| Production Example APMW-6 | APM-6 | 100 | 100 | 6.3 | 0 | 0 | 0 | 400 | 0.1> |
| Production Example APMW-7 | APM-7 | 100 | 300 | 3.5 | 0 | 0 | 0 | 400 | not |
| | | | | | | | | | emulsified |
| Production Example APMW-8 | APM-1 | 100 | — | — | 15 | 15 | 250 | 520 | 0.4 |
| Production Example APMW-9 | APM-8 | 100 | — | — | — | — | 250 | 200 | 0.1> |

TABLE 4-1

| | Composition | Solid | | Production | Production | Production | Production |
|---|---|---|---|---|---|---|---|
| Component | to be blended | concentration (%) | Items | Example 9(1) | Example 9(2) | Example 9(3) | Example 9(4) |
| A | Water-based | 20 | Kinds | APMW-1 | APMW-2 | APMW-3 | APMW-4 |
| | polyolefin | | Crystallinity (%) | 45 | 51 | 40 | 41 |
| | | | Mw (molecular weight) | 140 thousand | 120 thousand | 180 thousand | 60 thousand |
| | | | Amount of emulsifier | 0 | 0 | 0 | 0 |
| | | | (%) | | | | |
| | | | Amount to be blended | 25.27 | 25.27 | 25.27 | 25.27 |
| B | SUPERFLEX 150 | 30 | Amount to be blended | 12.03 | 12.03 | 12.03 | 12.03 |
| C | EPIREZ 5003W55 | 58 | Amount to be blended | 7.47 | 7.47 | 7.47 | 7.47 |
| D | Crosslinked acrylic | 24 | AC-No | AC-4 | AC-4 | AC-4 | AC-4 |
| | emulsion | | Tg (° C.) | 100 | 100 | 100 | 100 |
| | | | Amount of crosslinkable | 1 | 1 | 1 | 1 |
| | | | monomer (%) | | | | |
| | | | Amount to be blended | 6.02 | 6.02 | 6.02 | 6.02 |
| E | Pigment paste | 52 | Amount to be blended | 27.77 | 27.77 | 27.77 | 27.77 |
| | Deionized water | 0 | Amount to be blended | 19.28 | 19.28 | 19.28 | 19.28 |
| | Dynol604 | 100 | Amount to be blended | 0.72 | 0.72 | 0.72 | 0.72 |
| | ASE-60 | 28 | Amount to be blended | 1.44 | 1.44 | 1.44 | 1.44 |
| | Dimethylethanolamine | 0 | Amount to be blended | 0.01 | 0.01 | 0.01 | 0.01 |

| | | | | |
|---|---|---|---|---|
| Solid content of emulsifier (% of solid content)/ | 0.5 | 0.5 | 0.5 | 0.5 |
| resin solid content | | | | |

| | | | | Production | Production | Production |
|---|---|---|---|---|---|---|
| Component | Composition to be blended | Solid concentration (%) | Items | Example 9(5) | Example 9(6) | Example 9(7) |
| A | Water-based polyolefin | 20 | Kinds | APMW-1 | APMW-1 | APMW-1 |
| | | | Crystallinity (%) | 45 | 45 | 45 |
| | | | Mw (molecular weight) | 140 thousand | 140 thousand | 140 thousand |
| | | | Amount of emulsifier (%) | 0 | 0 | 0 |
| | | | Amount to be blended | 14.44 | 36.10 | 18.05 |
| B | SUPERFLEX 150 | 30 | Amount to be blended | 14.44 | 7.22 | 21.66 |
| C | EPIREZ 5003W55 | 58 | Amount to be blended | 9.96 | 6.22 | 4.98 |
| D | Crosslinked acrylic | 24 | AC-No | AC-4 | AC-4 | AC-4 |
| | emulsion | | Tg (° C.) | 100 | 100 | 100 |
| | | | Amount of crosslinkable | 1 | 1 | 1 |
| | | | monomer (%) | | | |
| | | | Amount to be blended | 6.02 | 6.02 | 6.02 |
| E | Pigment paste | 52 | Amount to be blended | 27.77 | 27.77 | 27.77 |
| | Deionized water | 0 | Amount to be blended | 25.21 | 14.50 | 19.36 |
| | Dynol604 | 100 | Amount to be blended | 0.72 | 0.72 | 0.72 |
| | ASE-60 | 28 | Amount to be blended | 1.44 | 1.44 | 1.44 |
| | Dimethylethanolamine | 0 | Amount to be blended | 0.01 | 0.01 | 0.01 |

| | | | |
|---|---|---|---|
| Solid content of emulsifier (% of solid content)/ | 0.5 | 0.5 | 0.5 |
| resin solid content | | | |

Described by the composition of a raw material itself

TABLE 4-2

| | Composition | Solid | | Production | Production | Production | Production |
|---|---|---|---|---|---|---|---|
| Component | to be blended | concentration (%) | Items | Example 9(8) | Example 9(9) | Example 9(10) | Example 9(11) |
| A | Water-based | 20 | Kinds | APMW-1 | APMW-1 | APMW-4 | APMW-4 |
| | polyolefin | | Crystallinity (%) | 45 | 45 | 41 | 41 |
| | | | Mw (molecular weight) | 140 thousand | 140 thousand | 60 thousand | 60 thousand |
| | | | Amount of emulsifier | 0 | 0 | 0 | 0 |
| | | | (%) | | | | |
| | | | Amount to be blended | 18.05 | 25.27 | 25.27 | 25.27 |
| B | SUPERFLEX 150 | 30 | Amount to be blended | 9.63 | 12.03 | 12.03 | 8.18 |
| C | EPIREZ 5003W55 | 58 | Amount to be blended | 11.20 | 7.47 | 7.47 | 7.47 |
| D | Crosslinked acrylic | 24 | AC-No | AC-4 | AC-2 | AC-6 | AC-5 |
| | emulsion | | Tg (° C.) | 100 | 60 | 130 | 100 |
| | | | Amount of crosslinkable | 1 | 1 | 1 | 30 |
| | | | monomer (%) | | | | |
| | | | Amount to be blended | 6.02 | 6.02 | 6.02 | 10.83 |
| E | Pigment paste | 52 | Amount to be blended | 27.77 | 27.77 | 27.77 | 27.77 |
| | Deionized water | 0 | Amount to be blended | 25.17 | 19.28 | 19.28 | 18.31 |
| | Dynol604 | 100 | Amount to be blended | 0.72 | 0.72 | 0.72 | 0.72 |
| | ASE-60 | 28 | Amount to be blended | 1.44 | 1.44 | 1.44 | 1.44 |
| | Dimethylethanolamine | 0 | Amount to be blended | 0.01 | 0.01 | 0.01 | 0.01 |

| | | | | |
|---|---|---|---|---|
| Solid content of emulsifier (% of solid content)/ | 0.5 | 0.5 | 0.5 | 0.9 |
| resin solid content | | | | |

| | | | | Production | Production | Production |
|---|---|---|---|---|---|---|
| Component | Composition to be blended | Solid concentration (%) | Items | Example 9(12) | Example 9(13) | Example 9(14) |
| A | Water-based polyolefin | 20 | Kinds | APMW-4 | APMW-8 | APMW-9 |
| | | | Crystallinity (%) | 41 | 45 | 45 |
| | | | Mw (molecular weight) | 60 thousand | 140 thousand | 56 thousand |
| | | | Amount of emulsifier (%) | 0 | 23 | 0 |
| | | | Amount to be blended | 25.27 | 25.27 | 25.27 |
| B | SUPERFLEX 150 | 30 | Amount to be blended | 12.03 | 12.03 | 12.03 |
| C | EPIREZ 5003W55 | 58 | Amount to be blended | 7.47 | 7.47 | 7.47 |
| D | Crosslinked acrylic emulsion | 24 | AC-No | AC-1 | AC-4 | AC-4 |
| | | | Tg (° C.) | 30 | 100 | 100 |
| | | | Amount of crosslinkable | 5 | 1 | 1 |
| | | | monomer (%) | | | |
| | | | Amount to be blended | 6.02 | 6.02 | 6.02 |
| E | Pigment paste | 52 | Amount to be blended | 27.77 | 27.77 | 27.77 |
| | Deionized water | 0 | Amount to be blended | 19.28 | 19.28 | 19.28 |
| | Dynol604 | 100 | Amount to be blended | 0.72 | 0.72 | 0.72 |
| | ASE-60 | 28 | Amount to be blended | 1.44 | 1.44 | 1.44 |
| | Dimethylethanolamine | 0 | Amount to be blended | 0.01 | 0.01 | 0.01 |

| | | | |
|---|---|---|---|
| Solid content of emulsifier (% of solid content)/ | 0.5 | 8.55 | 0.5 |
| resin solid content | | | |

Described by the composition of a raw material itself

TABLE 5-1

| | | | | Production | Production | Production |
|---|---|---|---|---|---|---|
| Component | Composition to be blended | Solid concentration (%) | Items | Example 9(15) | Example 9(16) | Example 9(17) |
| A | Water-based polyolefin | 20 | Kinds | APMW-5 | — | APMW-6 |
| | | | Crystallinity (%) | 33 | 60 (target value | 36 |
| | | | | | of synthesis) | |
| | | | Mw (molecular weight) | 110 thousand | Resin synthesis | 30 thousand |
| | | | Amount of emulsifier (%) | 0 | impossible | 0 |
| | | | Amount to be blended | 25.27 | | 25.27 |
| B | SUPERFLEX 150 | 30 | Amount to be blended | 12.03 | | 12.03 |
| C | EPIREZ 5003W55 | 58 | Amount to be blended | 7.47 | | 7.47 |
| D | Crosslinked acrylic | 24 | AC-No | AC-4 | | AC-4 |
| | emulsion | | Tg (° C.) | 100 | | 100 |
| | | | Amount of crosslinkable | 1 | | 1 |
| | | | monomer (%) | | | |
| | | | Amount to be blended | 6.02 | | 6.02 |
| E | Pigment paste | 52 | Amount to be blended | 27.77 | | 27.77 |
| | Deionized water | 0 | Amount to be blended | 19.28 | | 19.28 |
| | Dynol604 | 100 | Amount to be blended | 0.72 | | 0.72 |
| | ASE-60 | 28 | Amount to be blended | 1.44 | | 1.44 |
| | Dimethylethanolamine | 0 | Amount to be blended | 0.01 | | 0.01 |
| Solid content of emulsifier (% of solid content)/ | | | | 0.5 | — | 0.5 |
| resin solid content | | | | | | |
| | | | | Production | Production | Production |
| Component | Composition to be blended | Solid concentration (%) | Items | Example 9(18) | Example 9(19) | Example 9(20) |
| A | Water-based polyolefin | 20 | Kinds | APMW-7 | APMW-1 | APMW-1 |
| | | | Crystallinity (%) | 40 | 45 | 45 |
| | | | Mw (molecular weight) | 250 thousand | 140 thousand | 140 thousand |
| | | | Amount of emulsifier (%) | 0 | 0 | 0 |
| | | | Amount to be blended | emulsification | 7.22 | 46.93 |
| B | SUPERFLEX 150 | 30 | Amount to be blended | impossible | 19.25 | 4.81 |
| C | EPIREZ 5003W55 | 58 | Amount to be blended | | 9.96 | 3.73 |
| D | Crosslinked acrylic | 24 | AC-No | | AC-4 | AC-4 |
| | emulsion | | Tg (° C.) | | 100 | 100 |
| | | | Amount of crosslinkable | | 1 | 1 |
| | | | monomer (%) | | | |
| | | | Amount to be blended | | 6.02 | 6.02 |
| E | Pigment paste | 52 | Amount to be blended | | 27.77 | 27.77 |
| | Deionized water | 0 | Amount to be blended | | 27.62 | 8.57 |
| | Dynol604 | 100 | Amount to be blended | | 0.72 | 0.72 |
| | ASE-60 | 28 | Amount to be blended | | 1.44 | 1.44 |
| | Dimethylethanolamine | 0 | Amount to be blended | | 0.01 | 0.01 |

| | | | |
|---|---|---|---|
| Solid content of emulsifier (% of solid content)/ | — | 0.5 | 0.5 |
| resin solid content | | | |

Described by the composition of a raw material itself

TABLE 5-2

| | | Solid | | Production | Production | Production | Production | Production |
|---|---|---|---|---|---|---|---|---|
| | Composition to | concentration | | Example | Example | Example | Example | Example |
| Component | be blended | (%) | Items | 9(21) | 9(22) | 9(23) | 9(24) | 9(25) |
| A | Water-based | 20 | Kinds | APMW-1 | APMW-1 | APMW-1 | APMW-1 | APMW-4 |
| | polyolefin | | Crystallinity (%) | 45 | 45 | 45 | 45 | 41 |
| | | | Mw (molecular | 140 thousand | 140 thousand | 140 thousand | 140 thousand | 60 thousand |
| | | | weight) | | | | | |
| | | | Amount of emulsifier | 0 | 0 | 0 | 0 | 0 |
| | | | (%) | | | | | |
| | | | Amount to be blended | 25.27 | 14.44 | 25.91 | 25.27 | 25.27 |
| B | SUPERFLEX 150 | 30 | Amount to be blended | 2.41 | 7.22 | 14.80 | 12.03 | 8.18 |
| C | EPIREZ 5003W55 | 58 | Amount to be blended | 12.45 | 13.69 | 8.93 | 7.47 | 7.47 |
| D | Crosslinked acrylic | 24 | AC-No | AC-4 | AC-4 | — | AC-3 | AC-7 |
| | emulsion | | Tg (° C.) | 100 | 100 | — | 100 | 100 |
| | | | Amount of | 1 | 1 | — | 0 | 30 |
| | | | crosslinkable | | | | | |
| | | | monomer (%) | | | | | |
| | | | Amount to be blended | 6.02 | 6.02 | 0.00 | 6.02 | 10.83 |
| E | Pigment paste | 52 | Amount to be blended | 27.77 | 27.77 | 28.47 | 27.77 | 27.77 |
| | Deionized water | 0 | Amount to be blended | 23.92 | 28.69 | 19.66 | 19.28 | 18.31 |
| | Dynol604 | 100 | Amount to be blended | 0.72 | 0.72 | 0.74 | 0.72 | 0.72 |
| | ASE-60 | 28 | Amount to be blended | 1.44 | 1.44 | 1.48 | 1.44 | 1.44 |
| | Dimethylethanolamine | 0 | Amount to be blended | 0.01 | 0.01 | 0.01 | 0.01 | 0.01 |

| | | | | | |
|---|---|---|---|---|---|
| Solid content of emulsifier (% of solid | 0.5 | 0.5 | 0 | 0.5 | 2.5 |
| content)/resin solid content | | | | | |

Described by the composition of a raw material itself

TABLE 6

| | AC-1 | AC-2 | AC-3 | AC-4 | AC-5 | AC-6 | AC-7 |
|---|---|---|---|---|---|---|---|
| Styrene (parts) | 44.43 | 49.5 | 50 | 49.5 | 35 | 39.6 | 49.5 |
| Methyl methacrylate (parts) | 19 | 31.99 | 49.06 | 48.59 | 34.36 | 19.1 | 48.59 |
| n-Butyl acrylate (parts) | 31.57 | 17.51 | 0.92 | 0.91 | 0.64 | — | 0.91 |
| Isobornyl methacrylate (parts) | — | — | — | — | — | 40.3 | — |
| Divinyl benzene (parts) | 5 | 1 | 0 | 1 | 30 | 1 | 1 |
| Total (parts) | 100 | 100 | 100 | 100 | 100 | 100 | 100 |
| Tg(° C.) | 30 | 60 | 100 | 100 | 100 | 130 | 100 |

TABLE 7

| | | | Acrylic resin for clear coating material | | | | | | | | |
|---|---|---|---|---|---|---|---|---|---|---|---|
| | | | a | b | c | d | e | f | g | h | i |
| Feeding rate of butyl acetate | | | 42.0 | 43.0 | 41.0 | 42.0 | 42.0 | 42.0 | 64.0 | 43.0 | 51.0 |
| Used monomer and its amount | | Ethylhexyl acrylate (EHA) | 5.3 | 5.3 | 5.3 | 1.6 | 7.2 | 27.3 | 27.3 | 5.3 | 5.3 |
| | | t-Butyl methacrylate | 45.1 | 45.1 | 45.1 | 22.1 | 38.9 | 24.5 | 24.5 | 45.1 | 45.1 |
| | | (TBMA) | | | | | | | | | |
| | | Styrene (ST) | 10.0 | 10.0 | 10.0 | 10.0 | 10.0 | 10.0 | 10.0 | 10.0 | 10.0 |
| | | Methacrylic acid (MAA) | 1.1 | 1.1 | 1.1 | 1.1 | 1.1 | 1.1 | 1.1 | 1.1 | 1.1 |
| | | 2-Hydroxyethyl | | | | | | 37.1 | 37.1 | | |
| | | methacrylate (2HEMA) | | | | | | | | | |
| | | Hydroxybutyl acrylate | 38.5 | 38.5 | 38.5 | | | | | 38.5 | 38.5 |
| | | (HBA) | | | | | | | | | |
| | | Diethylene glycol | | | | | 42.8 | | | | |
| | | monoacrylate | | | | | | | | | |
| | | Plakcell FM-1(FM-1) | | | | 65.2 | | | | | |
| Total amount of acrylic monomer | | | 100.0 | 100.0 | 100.0 | 100.0 | 100.0 | 100.0 | 100.0 | 100.0 | 100.0 |
| Dropping | During | t-Butyl | 12.0 | 15.0 | 10.0 | 12.0 | 12.0 | 12.0 | 5.0 | 18.0 | 7.0 |
| | polymerization | peroxydiethylhexanoate | | | | | | | | | |
| polymerization | Post shot | t-Butyl | 0.5 | 0.5 | 0.5 | 0.5 | 0.5 | 0.5 | 0.5 | 0.5 | 0.5 |
| | | peroxydiethylhexanoate | | | | | | | | | |
| initiation solution | | Butyl acetate | 5.0 | 5.0 | 5.0 | 5.0 | 5.0 | 5.0 | 5.0 | 5.0 | 5.0 |

| | | | | | | | | | | |
|---|---|---|---|---|---|---|---|---|---|---|
| Resin vanish characteristics | Nonvolatile content | 70% | 70% | 70% | 70% | 70% | 70% | 60% | 70% | 65% |
| | Hydroxyl value | 150 | 150 | 150 | 150 | 150 | 160 | 160 | 150 | 150 |
| | Molecular weight (Mw) | 6000 | 4500 | 7000 | 6000 | 6000 | 6000 | 12000 | 4000 | 8500 |
| | OH equivalent weight | 534 | 534 | 534 | 534 | 534 | 501 | 584 | 534 | 575 |

TABLE 8

| | | | | | Clear | Clear |
|---|---|---|---|---|---|---|
| | | Clear coating | Clear coating | Clear coating | coating | coating |
| Kinds | | material 1 | material 2 | material 3 | material 4 | material 5 |
| Mixed | Kind and quantity of Acrylic resin | Acrylic resin a | Acrylic resin b | Acrylic resin c | Acrylic | Acrylic |
| component | | 100.0 | 100.0 | 100.0 | resin d | resin e |
| (parts by | | | | | 100.0 | 100.0 |
| mass) | Mixed solvent of Solfit AC/butyl acetate in | 15.0 | 15.0 | 15.0 | 15.0 | 15.0 |
| | a mass ratio of 3/2 (initial addition) | | | | | |
| | TINUVIN 292 (hindered amine) | 0.7 | 0.7 | 0.7 | 0.7 | 0.7 |
| | TINUVIN 384-2 (ultraviolet absorber) | 1.4 | 1.4 | 1.4 | 1.4 | 1.4 |
| | Mixed solvent of Solfit AC/butyl acetate in | 10.0 | 10.0 | 10.0 | 10.0 | 10.0 |
| | a mass ratio of 3/2 (intermediate addition) | | | | | |
| | BYK310 (surface control agent) | 0.7 | 0.7 | 0.7 | 0.7 | 0.7 |
| | BYKETOL SPECIAL (surface control agent) | 2.8 | 2.8 | 2.8 | 2.8 | 2.8 |
| | Dibutyl tin dilaurate (hardening catalyst) | 0.1 | 0.1 | 0.1 | 0.1 | 0.1 |
| | R-271 hardening agent (polyisocyanate) | 47.6 | 47.6 | 47.6 | 47.6 | 47.6 |
| | Nonvolatile content: 75%, NCO: 16.5% | | | | | |
| | Mixed solvent of SOLFIT AC/butyl acetate | 13.0 | 10.0 | 20.0 | 20.0 | 20.0 |
| | in a mass ratio of 3/2 (for dilution control) | | | | | |

| | | | | | |
|---|---|---|---|---|---|
| Total | 191.3 | 188.3 | 198.3 | 198.3 | 198.3 |
| Nonvolatile content at time of applying | 57% | 58% | 55% | 55% | 55% |
| OH equivalent weight/NCO equivalent weight | 1/1 | 1/1 | 1/1 | 1/1 | 1/1 |

| | | | | |
|---|---|---|---|---|
| | Clear coating | Clear coating | Clear coating | Clear coating |
| Kinds | material 6 | material 7 | material 8 | material 9 |

| | | | | | |
|---|---|---|---|---|---|
| Mixed | Kind and quantity of Acrylic resin | Acrylic resin f | Acrylic resin g | Acrylic resin h | Acrylic resin i |
| component | | 100.0 | 100.0 | 100.0 | 100.0 |
| (parts by | Mixed solvent of Solfit AC/butyl acetate in | 15.0 | 15.0 | 15.0 | 15.0 |
| mass) | a mass ratio of 3/2 (initial addition) | | | | |
| | TINUVIN 292 (hindered amine) | 0.7 | 0.7 | 0.7 | 0.7 |
| | TINUVIN 384-2 (ultraviolet absorber) | 1.4 | 1.4 | 1.4 | 1.4 |
| | Mixed solvent of Solfit AC/butyl acetate in | 10.0 | 10.0 | 10.0 | 10.0 |
| | a mass ratio of 3/2 (intermediate addition) | | | | |
| | BYK310 (surface control agent) | 0.7 | 0.7 | 0.7 | 0.7 |
| | BYKETOL SPECIAL (surface control agent) | 2.8 | 2.8 | 2.8 | 2.8 |
| | Dibutyl tin dilaurate (hardening catalyst) | 0.1 | 0.1 | 0.1 | 0.1 |
| | R-271 hardening agent (polyisocyanate) | 50.8 | 43.6 | 47.6 | 44.2 |
| | Nonvolatile content: 75%, NCO: 16.5% | | | | |
| | Mixed solvent of SOLFIT AC/butyl acetate | 17.0 | 57.0 | 7.0 | 27.0 |
| | in a mass ratio of 3/2 (for dilution control) | | | | |

| | | | | |
|---|---|---|---|---|
| Total | 198.5 | 231.3 | 185.3 | 201.9 |
| Nonvolatile content at time of applying | 56% | 41% | 59% | 50% |
| OH equivalent weight/NCO equivalent weight | 1/1 | 1/1 | 1/1 | 1/1 |

TABLE 9-1

| | | Example 1 | Example 2 | Example 3 | Example 4 | Example 5 | Example 6 | Example 7 | Example 8 | Example 9 |
|---|---|---|---|---|---|---|---|---|---|---|
| | | Production | Production | Production | Production | Production | Production | Production | Production | Production |
| Water-based primer coating | | Example | Example | Example | Example | Example | Example | Example | Example | Example |
| material composition | | 9(1) | 9(2) | 9(3) | 9(4) | 9(5) | 9(6) | 9(7) | 9(8) | 9(9) |
| Coating material (i) | Water-based bright | I | I | I | I | I | I | I | I | I |
| | base metallic I | | | | | | | | | |
| Coating material (ii) | Water-based bright | II | II | II | II | II | II | II | II | II |
| | base metallic II | | | | | | | | | |
| Clear coating | Kinds | Clear | Clear | Clear | Clear | Clear | Clear | Clear | Clear | Clear |
| material | | coating | coating | coating | coating | coating | coating | coating | coating | coating |
| | | material 1 | material 1 | material 1 | material 1 | material 1 | material 1 | material 1 | material 1 | material 1 |
| | Nonvolatile content | ◯ | ◯ | ◯ | ◯ | ◯ | ◯ | ◯ | ◯ | ◯ |
| Coating film | Cross-cut peeling | ◯ | ◯ | ◯ | ◯ | ◯ | ◯ | ◯ | ◯ | ◯ |
| performance | test | | | | | | | | | |
| | Finished appearance | ◯ | ◯ | ◯ | ◯ | ◯ | ◯ | ◯ | ◯ | ◯ |
| | Brightness | ◯ | ◯ | ◯ | ◯ | ◯ | ◯ | ◯ | ◯ | ◯ |

TABLE 9-2

| | | Example 10 | Example 11 | Example 12 | Example 13 | Example 14 | Example 15 | Example 16 | Example 17 |
|---|---|---|---|---|---|---|---|---|---|
| | | Production | Production | Production | Production | Production | Production | Production | Production |
| Water-based primer | | Example | Example | Example | Example | Example | Example | Example | Example |
| coating material composition | | 9(10) | 9(11) | 9(12) | 9(14) | 9(1) | 9(1) | 9(1) | 9(1) |
| Coating | Water-based bright | I | I | I | I | I | I | I | I |
| material (i) | base metallic I | | | | | | | | |
| Coating | Water-based bright | II | II | II | II | II | II | II | II |
| material (ii) | base metallic II | | | | | | | | |
| Clear coating | Kinds | Clear coating | Clear coating | Clear coating | Clear coating | Clear coating | Clear coating | Clear coating | Clear coating |
| material | | material 1 | material 1 | material 1 | material 1 | material 2 | material 3 | material 4 | material 5 |
| | Nonvolatile content | ◯ | ◯ | ◯ | ◯ | ◯ | ◯ | ◯ | ◯ |
| Coating film | Cross-cut peeling | ◯ | ◯ | ◯ | ◯ | ◯ | ◯ | ◯ | ◯ |
| performance | test | | | | | | | | |
| | Finished appearance | ◯ | ◯ | ◯ | ◯ | ◯ | ◯ | ◯ | ◯ |
| | Brightness | ◯ | ◯ | ◯ | ◯ | ◯ | ◯ | ◯ | ◯ |

TABLE 10-1

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 5 | Example 6 | Example 7 |
| | | Production | Production | Production | Production | Production | Production | Production |
| Water-based primer | | Example | Example | Example | Example | Example | Example | Example |
| coating material composition | | 9(15) | 9(17) | 9(19) | 9(20) | 9(21) | 9(22) | 9(23) |
| Coating | Water-based bright | I | I | I | I | I | I | I |
| material (i) | base metallic I | | | | | | | |
| Coating | Water-based bright | II | II | II | II | II | II | II |
| material (ii) | base metallic II | | | | | | | |
| Clear coating | Kinds | Clear coating | Clear coating | Clear coating | Clear coating | Clear coating | Clear coating | Clear coating |
| material | | material 1 | material 1 | material 1 | material 1 | material 1 | material 1 | material 1 |
| | Nonvolatile content | ◯ | ◯ | ◯ | ◯ | ◯ | ◯ | ◯ |
| Coating film | Cross-cut peeling test | ◯ | ◯ | X | ◯ | ◯ | ◯ | ◯ |
| performance | Finished appearance | Δ | X | X | X | X | X | X |
| | Brightness | X | X | X | X | X | X | X |

TABLE 10-2

| | | Comparative | Comparative | Comparative | Comparative | Comparative | Comparative | Comparative |
|---|---|---|---|---|---|---|---|---|
| | | Example 8 | Example 9 | Example 10 | Example 11 | Example 12 | Example 13 | Example 14 |
| | | Production | Production | Production | Production | Production | Production | Production |
| Water-based primer | | Example | Example | Example | Example | Example | Example | Example |
| coating material composition | | 9(24) | 9(13) | 9(1) | 9(1) | 9(1) | 9(1) | 9(25) |
| Coating | Water-based bright base metallic I | I | I | I | I | I | I | I |
| material (i) | | | | | | | | |
| Coating | Water-based bright base metallic II | II | II | II | II | II | II | II |
| material (ii) | | | | | | | | |
| Clear coating | Kinds | Clear coating | Clear coating | Clear coating | Clear coating | Clear coating | Clear coating | Clear coating |
| material | | material 1 | material 1 | material 6 | material 7 | material 8 | material 9 | material 1 |
| | Nonvolatile content | ◯ | ◯ | ◯ | X | ◯ | X | ◯ |
| Coating film | Cross-cut peeling test | ◯ | ◯ | ◯ | ◯ | ◯ | ◯ | ◯ |
| performance | Finished appearance | X | X | X | X | X | X | X |
| | Brightness | X | X | X | X | X | X | X |

It became evident from Table 9 that multilayer coating films obtained in Examples have favorable brightness and favorable appearances. On the other hand, it is evident from Table 10 that multilayer coating films, obtained in Comparative Examples, which satisfy all performance, were not obtained.

### INDUSTRIAL APPLICABILITY

Since the method for forming a bright coating film of the present invention has low energy cost and is simple, it can be suitably implemented on an industrial scale.

### BRIEF DESCRIPTIONS OF THE DRAWINGS

FIG. 1 is a schematic view showing a method for measuring a melting point of a resin, and

FIG. 2 is a schematic view showing a method for measuring a glass transition temperature (Tg) of a resin.

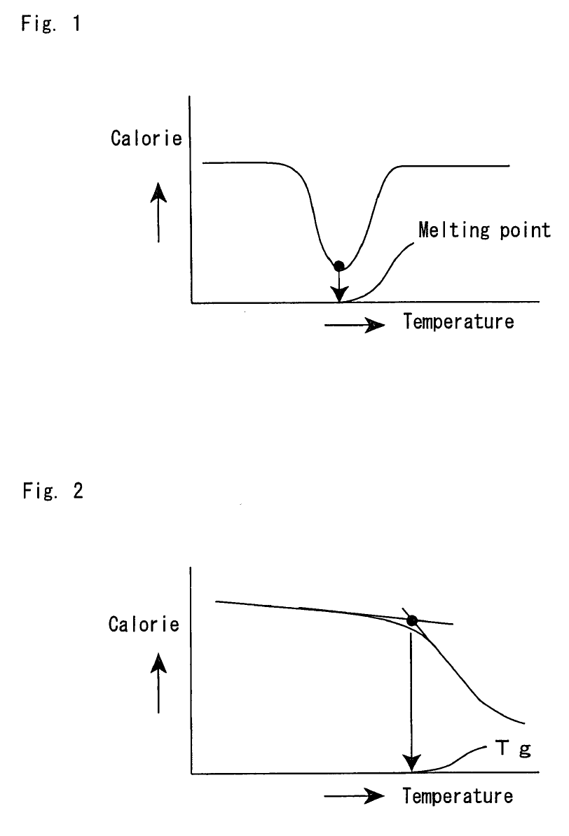

1. A method for forming a bright coating film, comprising the steps of:
(1) applying a water-based primer coating material composition to a substrate to form a water-based primer coating film;
(2) applying a water-based bright coating material (i) to said water-based primer coating film to form a first base coating film;
(3) applying a water-based bright coating material (ii) to said first base coating film to form a second base coating film;
(4) applying a high-solid clear coating material to said second base coating film to form a clear coating film; and
(5) heat-curing said water-based primer coating film, said first base coating film, said second base coating film, and said clear coating film simultaneously to form a cured coating film,
wherein said water-based primer coating material composition includes a water-based non-chlorinated polyolefin resin (A), a water-based polyurethane resin (B), a water-based epoxy resin (C), and an internally crosslinked acrylic particle emulsion (D), and an amount of an emulsifier is 2% by mass or less on the solid content equivalent basis with respect to 100% by mass of a total amount of said resin (A), said resin (B), said resin (C) and said emulsion (D),
wherein a content of said resin (A) is 15 to 60% by mass, a content of said resin (B) is 10 to 50% by mass, a content of said resin (C) is 20 to 50% by mass, and a content of said emulsion (D) is 5 to 20% by mass on the solid content equivalent basis with respect to 100% by mass of the total amount of said resin (A), said resin (B), said resin (C) and said emulsion (D), and
said resin (A) is a water-based polypropylene resin having a crystallinity of 35 to 55% and a weight average molecular weight of 50000 to 200000, and
wherein said high-solid clear coating material includes an acrylic resin.

2. The method for forming a bright coating film according to claim 1,
wherein the resin (A) is obtained by use of a metallocene catalyst.

3. The method for forming a bright coating film according to claim 1,
wherein the resin (A) is a water-based polypropylene resin which is converted to a water-based resin without using an emulsifier.

4. The method for forming a bright coating film according to claim 1,
wherein the resin (A) is a modified polypropylene resin having a structure, in which a hydrophilic polymer is bound to an unsaturated organic acid derivative, as a modified portion.

5. The method for forming a bright coating film according to claim 4,
wherein the unsaturated organic acid derivative is at least one compound selected from the group consisting of an unsaturated carboxylic acid, dicarboxylic acid anhydride, and dicarboxylic acid anhydride monoester.

6. The method for forming a bright coating film according to claim 4,
wherein the hydrophilic polymer is a polyether resin having a polyalkylene structure.

7. The method for forming a bright coating film according to claim 1,
wherein the emulsion (D) is obtained by emulsion polymerization of a monomer composition containing an ethylenic unsaturated monomer and a crosslinkable monomer, and
a glass transition temperature of a non-crosslinked polymer obtained by polymerization of said ethylenic unsaturated monomer is 50 to 140° C., and
a content of said crosslinkable monomer is 0.1 to 50% by mass with respect to 100% by mass of said monomer composition.

8. The method for forming a bright coating film according to claim 1,
wherein the high-solid clear coating material contains an acrylic resin and polyisocyanate.

9. The method for forming a bright coating film according to claim 8,
wherein the acrylic resin is formed by polymerization of a monomer composition containing at least one of (meth)acrylic monomers having a hydroxyl group represented by any one of the following formulae (1) to (3): 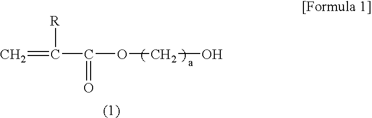
wherein “R” represents H (hydrogen) or CH₃ and “a” represents an integer of 3 or 4, 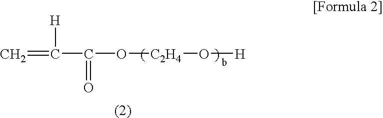
wherein “b” is 2 to 5 in the mean, and 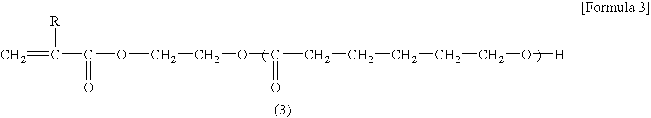
wherein “R” is the same as defined above.

10. The method for forming a bright coating film according to claim 8,
wherein the high-solid clear coating material has a nonvolatile content of 52% by mass or more during application.

11. The method for forming a bright coating film according to claim 8,
wherein the high-solid clear coating material has a nonvolatile content of 55% by mass or more during application.

12. The method for forming a bright coating film according to claim 8,
wherein the high-solid clear coating material has an efflux viscosity of 15 to 25 seconds measured in accordance with JIS K 5600-2-2-3.
